(19) United States
(12) Patent Application Publication
(10) Pub. No.: US 2023/0393230 A1
(43) Pub. Date: Dec. 7, 2023

(54) METHODS FOR AGGREGATING DOWNLINK POSITIONING REFERENCE SIGNALS

(71) Applicant: Telefonaktiebolaget LM Ericsson (PUBL), Stockholm (SE)

(72) Inventors: Siva Muruganathan, STITTSVILLE (CA); Florent Munier, VÄSTRA FRÖLUNDA (SE); Ritesh Shreevastav, UPPLANDS VÄSBY (SE); Per Ernström, STOCKHOLM (SE)

(21) Appl. No.: 18/248,725

(22) PCT Filed: Oct. 15, 2021
(86) PCT No.: PCT/IB2021/059533

§ 371 Date: Apr. 12, 2023

Related U.S. Application Data
(60) Provisional application No. 63/092,624, filed on Oct. 16, 2020.

(51) Int. Cl. G01S 5/00; H04L 5/00

(52) U.S. Cl. CPC G01S 5/0036; H04L 5/0051; H04L 5/0092; G01S 2205/008

(57) ABSTRACT

According to certain embodiments, a method performed by a wireless device comprises receiving an indication from a network. The indication indicates whether the wireless device can jointly process two or more downlink (DL) positioning reference signal (PRS) resources as aggregated DL PRS resources. The method further comprises performing joint processing of the aggregated DL PRS resources to produce a measurement, the joint processing performed based at least in part on the indication indicating that the wireless device can jointly process the two or more downlink DL PRS resources as aggregated DL PRS resources.

### TECHNICAL FIELD

Certain embodiments of the present disclosure relate, in general, to wireless networks and, more particularly, to aggregating downlink positioning reference signals.

### BACKGROUND

The Third Generation Partnership Project (3GPP) refers to a partnership among telecommunications standard development organizations that produce reports and specifications defining 3GPP technologies. Topics of discussion in 3GPP include positioning signals, carrier aggregation (CA), and multi-Transmission and Reception Point (TRP) configuration, as further summarized below.

Positioning Signals

Positioning has been a topic in Long Term Evolution (LTE) standardization since 3GPP Release 9 (Rel-9). The primary objective was initially to fulfill regulatory requirements for emergency call positioning, however, other use cases are becoming important. An example of one such use case includes like positioning for Industrial Internet-of-Things (I-IoT). Positioning in New Radio (NR) is supported by the architecture shown in FIG. 1. The Location Management Function (LMF) is the location node in NR. There are also interactions between the location node and the gNodeB (gNB, the base station in NR) via the NR Positioning Protocol A (NRPPa) protocol. The interactions between the gNodeB and the device is supported via the Radio Resource Control (RRC) protocol, while the location node interfaces with the user equipment (UE) via the LTE positioning protocol (LPP). LPP is common to both NR and LTE. Note that in the architecture shown in FIG. 1, the gNB and the next generation eNodeB (ng-eNB) need not necessarily both be present. Also note that in the architecture shown in FIG. 1, when both the gNB and ng-eNB are present, the NG-C interface is only present for one of them.

In the legacy LTE standards, the following techniques are supported:
Enhanced Cell ID. Essentially cell ID information to associate the device to the serving area of a serving cell, and then additional information to determine a finer granularity position.
Assisted Global Navigation Satellite System (GNSS). GNSS information retrieved by the device, supported by assistance information provided to the device from Evolved Serving Mobile Location Center (E-SMLC).
Observed Time Difference of Arrival (OTDOA). The device estimates the time difference of reference signals from different base stations and sends to the E-SMLC for multi-lateration.
Uplink Time Difference of Arrival (UTDOA). The device is requested to transmit a specific waveform that is detected by multiple location measurement units (e.g., an eNB) at known positions. These measurements are forwarded to E-SMLC for multi-lateration

In NR Rel-16, a number of positioning features were specified. For example, a new downlink (DL) reference signal, the NR DL Positioning Reference Signal (PRS), was specified. The main benefit of the NR DL PRS signal in relation to the LTE DL PRS is the increased bandwidth, configurable from 24 to 272 resource blocks (RBs), which gives a big improvement in time of arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel-16.

In NR Rel-16, the DL PRS is configured by each cell separately. The location server (LMF) collects all configuration via the NRPPa protocol before sending an assistance data (AD) message to the UE via the LPP protocol.

Rel-16 NR DL PRS is organized in a 3-level hierarchy:
PRS frequency layer: gathers PRS resource sets from (potentially) multiple base station, having common parameters in common. If two resource sets are in the same frequency layer, they:
   Operate in the same band with the same subcarrier spacing
   Have the same comb factor
   Have the same starting PRB and bandwidth
PRS Resource set: corresponds to a collection of PRS beams (resources) which are all originating from the same TRP. All resource in the same set have the same comb factor
PRS resource: correspond to a beam transmitting the PRS

In NR Rel-16, enhancements of the NR uplink (UL) sounding reference signal (SRS) were specified. The Rel-16 NR SRS for positioning allows for a longer signal, up to 12 symbols (compared to 4 symbols in Rel-15), and a flexible position in the slot (only last six symbols of the slot can be used in Rel-15). It also allows for a staggered comb resource element (RE) pattern for improved TOA measurement range and for more orthogonal signals based on comb offsets (comb 2, 4 and 8) and cyclic shifts. The use of cyclic shifts longer than the orthogonal frequency-division multiplexing (OFDM) symbol divided by the comb factor is, however, not supported by Rel-16 even though this is the main advantage of comb-staggering at least in indoor scenarios. Power control based on neighbor cell synchronization signal blocks (SSB)/DL PRS is supported as well as spatial Quasi Co-Location (QCL) relations towards a Channel State Information Reference Signal (CSI-RS), an synchronization signal block (SSB), a DL PRS or another SRS.

In NR Rel-16, the following UE measurements are specified:
DL reference signal time difference (RSTD), e.g., allowing for DL time differene of arrival (TDOA) positioning
Multi-cell UE Receive-Transmit (Rx-Tx) Time Difference measurement, allowing for multi cell round trip time (RTT) measurements
DL PRS reference signal received power (RSRP)

In NR Rel-16, the following gNB measurements are specified
Uplink (UL) Relative Time of Arrival (RTOA) (UL-RTOA), useful for UL TDOA positioning
gNB Rx-Tx time difference, useful for multi-cell RTT measurements
UL SRS-RSRP
Angle of Arrival (AoA) and Zenith angle Of Arrival (ZoA)

In December 2019, 3GPP initiated a study item on positioning for NR Rel-17. The focus of the study item was Industrial IoT scenarios. One of the objectives of the study item included studying high positioning accuracy (horizontal and vertical) with low latency and network efficiency (scalability, reference signal (RS) overhead, etc.). In this regard, aggregating DL PRS resources and performing joint measurement on the aggregated PRS resources to improve positioning accuracy is an area that has been agreed to be studied in 3GPP RAN1. The aggregated PRS resources allows the UE to coherently/jointly process these PRS resources for improved positioning accuracy. In RAN1 #102-e meeting in August 2020, the following agreement was made:

Agreement:
Aggregating multiple DL positioning frequency layers of the same or different bands for improving positioning performance for both intra-band and inter-band scenarios will be investigated in Rel-17, which may take into account at least the following
   The scenarios and performance benefits of aggregating multiple DL positioning frequency layers
   The impact of channel spacing, timing offset, phase offset, frequency error, and power imbalance among component carriers (CCs) to the positioning performance for intra-band contiguous/non-contiguous and inter-band scenarios
   UE complexity considerations

Early results show potential performance improvements in positioning accuracy when multiple PRS resources are aggregated and jointly processed, see R1-2006810, ‘Potential Enhancements for NR Rel-17 Positioning,’ 3GPP TSG RAN WG1 #102-e, Aug. 17th-28th, 2020.

Carrier Aggregation

Carrier aggregation is used since LTE-Advanced in order to increase the bandwidth, and thereby increase the bitrate. In NR, with inter-band carrier aggregation, it is also possible to gain coverage. Aggregating a 5th generation (5G) low-band with a 5G high-band can improve high-band coverage by up to 10 dB. Each aggregated carrier is referred to as a component carrier, CC. depending upon the UE and/or network (NW) capability; different combinations/aggregation of NR operating bands and number of CCs can be achieved.

The NW may configure the UE with Carrier Aggregation, by configuring one or more secondary cells in addition to the primary cell that is configured during connection establishment. The primary cell plays an essential role with respect to security (i.e., it provides the security inputs) and upper layer system information (i.e., the non-access stratum (NAS) mobility information, such as tracking area identity (TAI)). Secondary cells are used to provide additional downlink and optionally uplink radio resources. An example is described in 3GPP Technical Specification (TS) 36.331 v16.0.0.

Multi-TRP

A cell can consist of multiple TRPs with each TRP located in distinct coordinates as shown in FIG. 2. This sort of configuration is expected to be used in I-IOT scenarios. As an example, one cell with 10, 20, or even more TRPs may be used to cover a complete factory hall. It should be possible to exploit this sort of scenario (where a serving cell has multiple TRPs located in distinct co-ordinates for positioning (e.g., three distinct co-ordinates are required to perform multi-lateration positioning).

### SUMMARY

There currently exist certain challenges. For example, although the notion of aggregating downlink PRS for achieving improved positioning accuracy was discussed in RAN1 #102-e, how to efficiently signal the aggregation to the UE such that the UE performs PRS aggregation is still unknown in the prior art. Hence, the efficient signaling of aggregated downlink PRS is an open problem that needs to be solved.

Certain aspects of the present disclosure and their embodiments may provide solutions to these or other challenges. For example, certain embodiments introduce the following signaling for DL-PRS aggregation:
Signaling of Aggregated DL PRS resources that can be coherently/jointly processed from the LMF or the serving gNB to the UE
Signaling of Aggregated DL PRS resources from serving or neighbor gNBs to the LMF

There are, proposed herein, various embodiments which address one or more of the issues disclosed herein.

According to certain embodiments, a method performed by a wireless device comprises receiving an indication from a network. The indication indicates whether the wireless device can jointly process two or more DL PRS resources as aggregated DL PRS resources. The method further comprises performing joint processing of the aggregated DL PRS resources to produce a measurement, the joint processing performed based at least in part on the indication indicating that the wireless device can jointly process the two or more downlink DL PRS resources as aggregated DL PRS resources.

According to certain embodiments, a wireless device comprises power supply circuitry and processing circuitry. The power supply circuitry is configured to supply power to the wireless device. The processing circuitry is configured to receive an indication from a network. The indication indicates whether the wireless device can jointly process two or more DL PRS resources as aggregated DL PRS resources. The processing circuitry is configured to perform joint processing of the aggregated DL PRS resources to produce a measurement. The joint processing is performed based at least in part on the indication indicating that the wireless device can jointly process the two or more downlink DL PRS resources as aggregated DL PRS resources.

The above described method and/or wireless device may further comprise any suitable features, such as one or more of the following features:

In certain embodiments, performing the joint processing is further based on determining that one or more conditions for jointly processing the two or more DL PRS resources have been met.

In certain embodiments, performing the joint processing is further based on determining that a condition has been met that requires the two or more DL PRS resources being jointly processed to be transmitted from the same TRP.

In certain embodiments, performing the joint processing is further based on determining that a condition has been met that requires the two or more DL PRS resources being jointly processed to be received by the wireless device in the same slot.

In certain embodiments, performing the joint processing is further based on determining that a condition has been met that requires the two or more DL PRS resources being jointly processed to be received by the wireless device in the same symbol.

In certain embodiments, performing the joint processing is further based on determining that a condition has been met that requires the two or more DL PRS resources being jointly processed to be limited to a single repetition.

In certain embodiments, performing the joint processing is further based on determining that a condition has been met that requires the two or more DL PRS resources being jointly processed to be received by the wireless device with the same QCL information.

In certain embodiments, performing the joint processing is further based on determining that a condition has been met that requires the two or more DL PRS resources being jointly processed to belong to different frequency layers.

In certain embodiments, performing the joint processing is further based on determining that a condition has been met that requires the two or more DL PRS resources being jointly processed to use the same subcarrier spacing.

Certain embodiments indicate, to the network, the measurement produced by joint processing of the aggregated DL PRS resources. Certain embodiments indicate the measurement to a location node. Certain embodiments indicate the measurement to a radio network node.

In certain embodiments, the indication indicating whether the wireless device can jointly process the two or more DL PRS resources is based on a phase difference between a first carrier associated with a first DL PRS resource and a second carrier associated with a second DL PRS resource. For example, the indication indicates that the two or more DL PRS resources can be jointly processed when the phase difference indicates that the first carrier and the second carrier are sufficiently coherent. In certain embodiments, whether the first carrier and the second carrier are sufficiently coherent is based on whether a coherency value exceeds a threshold.

In certain embodiments, the indication indicating whether the wireless device can jointly process the two or more DL PRS resources is received from a location node.

In certain embodiments, the indication indicating whether the wireless device can jointly process the two or more DL PRS resources is received via NAS signaling.

In certain embodiments, the indication indicating whether the wireless device can jointly process the two or more DL PRS resources is received according to a positioning protocol or an OAM message.

In certain embodiments, the indication indicating whether the wireless device can jointly process the two or more DL PRS resources is received from a radio network node.

In certain embodiments, the indication indicating whether the wireless device can jointly process the two or more DL PRS resources is received via RRC signaling.

In certain embodiments, the indication indicating whether the wireless device can jointly process the two or more DL PRS resources is received via DCI.

In certain embodiments, the indication indicating whether the wireless device can jointly process the two or more DL PRS resources comprises a first index associated with a first DL PRS resource and a second index associated with a second DL PRS resource. The indication indicates that the first DL PRS resource and the second DL PRS resource can be jointly processed when the first index is the same as the second index.

In certain embodiments, the indication indicating whether the wireless device can jointly process the two or more DL PRS resources is received in a DL PRS resource configuration.

In certain embodiments, the indication indicating whether the wireless device can jointly process the two or more DL PRS resources is received at a frequency layer level.

In certain embodiments, the indication indicating whether the wireless device can jointly process the two or more DL PRS resources is configured at a DL PRS resource set level.

Certain embodiments send the network information indicating a maximum number of DL PRS resources that the wireless device is capable of jointly processing.

According to certain embodiments, a method performed by a network node comprises sending an indication to a wireless device. The indication indicates whether the wireless device can jointly process two or more DL PRS resources as aggregated DL PRS resources.

According to certain embodiments, a network node comprises power supply circuitry and processing circuitry. The power supply circuitry is configured to supply power to the network node. The processing circuitry is configured to send an indication to a wireless device. The indication indicating whether the wireless device can jointly process two or more downlink DL PRS resources as aggregated DL PRS resources.

The above described method and/or network node may further comprise any suitable features, such as one or more of the following features:

Certain embodiments send the wireless device information about one or more conditions that must be met in order to jointly process the two or more DL PRS resources.

In certain embodiments, the one or more conditions comprise a condition that requires the two or more DL PRS resources being jointly processed to be transmitted from the same TRP.

In certain embodiments, the one or more conditions comprise a condition that requires the two or more DL PRS resources being jointly processed to be received by the wireless device in the same slot.

In certain embodiments, the one or more conditions comprise a condition that requires the two or more DL PRS resources being jointly processed to be received by the wireless device in the same symbol.

In certain embodiments, the one or more conditions comprise a condition that requires the two or more DL PRS resources being jointly processed to be limited to a single repetition.

In certain embodiments, the one or more conditions comprise a condition that requires the two or more DL PRS resources being jointly processed to be received by the wireless device with the same QCL information.

In certain embodiments, the one or more conditions comprise a condition that requires the two or more DL PRS resources being jointly processed to belong to different frequency layers.

In certain embodiments, the one or more conditions comprise a condition that requires the two or more DL PRS resources being jointly processed to use the same subcarrier spacing.

In certain embodiments, the indication sent to the wireless device indicates that the two or more DL PRS resources can be jointly processed. Certain embodiments receive, from the wireless device, information indicating a measurement based on the wireless device jointly processing the two or more DL PRS resources as aggregated DL PRS resources.

In certain embodiments, the indication sent to the wireless device indicates that the two or more DL PRS resources cannot be jointly processed. Certain embodiments receive, from the wireless device, information indicating a measurement based on the wireless device processing only one of the two or more DL PRS resources.

Certain embodiments determine whether the two or more DL PRS resources can be jointly processed. For example, determining whether the two or more DL PRS resources can be jointly processed is based on a phase difference between a first carrier associated with a first DL PRS resource and a second carrier associated with a second DL PRS resource. Certain embodiments determine that the two or more DL PRS resources can be jointly processed when the phase difference indicates that the first carrier and the second carrier are sufficiently coherent. Certain embodiments determine that the two or more DL PRS resources cannot be jointly processed when the phase difference indicates that the first carrier and the second carrier are not sufficiently coherent. For example, whether the first carrier and the second carrier are sufficiently coherent is based on whether a coherency value exceeds a threshold.

In certain embodiments, the network node comprises a location node.

In certain embodiments, the indication is sent via NAS signaling.

In certain embodiments, the indication is sent according to a positioning protocol or an OAM message.

In certain embodiments, the network node comprises a radio network node.

In certain embodiments, the indication is sent via RRC signaling.

In certain embodiments, the indication is sent via DCI.

In certain embodiments, the indication comprises a first index associated with a first DL PRS resource and a second index associated with a second DL PRS resource. The indication indicates that the first DL PRS resource and the second DL PRS resource can be jointly processed when the first index is the same as the second index.

In certain embodiments, the indication is sent in a DL PRS resource configuration.

In certain embodiments, the indication is sent at a frequency layer level.

In certain embodiments, the indication is configured at a DL PRS resource set level.

In certain embodiments, a number of DL PRS resources that the indication indicates can be jointly processed is less than a maximum number of DL PRS resources that the wireless device is capable of jointly processing. Certain embodiments receive the maximum number of DL resources that the wireless device is capable of jointly processing from the wireless device. In certain embodiments, the maximum number of DL resources that the wireless device is capable of jointly process is defined in a standard.

According to certain embodiments, a method performed by a radio network node comprises sending an indication to a location node. The indication indicates whether two or more downlink DL PRS resources can be jointly processed by a wireless device as aggregated DL PRS resources to produce a measurement.

According to certain embodiments, a radio network node comprises power supply circuitry and processing circuitry. The power supply circuitry is configured to supply power to the radio network node. The processing circuitry is configured to send an indication to a location node. The indication indicates whether two or more DL PRS resources can be jointly processed by a wireless device as aggregated DL PRS resources to produce a measurement.

The above described method and/or radio network node may further comprise any suitable features, such as one or more of the following features:

In certain embodiments, the indication is sent in response to a receiving a request from the location node to provide information on TRPs hosted by the radio network node.

Certain embodiments determine whether the two or more DL PRS resources can be jointly processed.

According to certain embodiments, a method performed by a location node comprises receiving an indication from a radio network node. The indication indicates whether two or more downlink DL PRS resources can be jointly processed by a wireless device as aggregated DL PRS resources to produce a measurement. The method comprises sending the wireless device a request to provide a DL PRS measurement. The request indicates whether the two or more DL PRS resources can be jointly processed as aggregated DL PRS resources.

According to certain embodiments, a location node comprises power supply circuitry and processing circuitry. The power supply circuitry is configured to supply power to the location node. The processing circuitry is configured to receive an indication from a radio network node. The indication indicates whether two or more DL PRS resources can be jointly processed by a wireless device as aggregated DL PRS resources to produce a measurement. The processing circuitry is further configured to send the wireless device a request to provide a DL PRS measurement. The request indicates whether the two or more DL PRS resources can be jointly processed as aggregated DL PRS resources.

The above described method and/or location node may further comprise any suitable features, such as one or more of the following features:

In certain embodiments, the request is sent via NAS signaling.

In certain embodiments, the request is sent according to a positioning protocol or an OAM message.

Certain embodiments receive, from the wireless device, information indicating the measurement that the wireless device produced by joint processing of the aggregated DL PRS resources. Certain embodiments determine a position of the wireless device based at least in part on the information indicating the measurement.

Certain embodiments may provide one or more of the following technical advantage(s). In certain embodiments, with the proposed signaling enhancements, the gNB's can indicate for which DL PRS reference signals coherency can be guaranteed so that the UE can coherently/jointly process the DL PRS reference signals.

A benefit of coherent/joint processing of DL PRS reference signals when coherency can be guaranteed is improved positioning accuracy as illustrated in FIG. 3. In particular, FIG. 3 illustrates an example of simulation results showing the gain in positioning accuracy from carrier aggregation of two coherent carriers. The results also show that the gain deteriorates if the carriers are not fully coherent. For completely incoherent carriers (random phase difference), it can even reduce performance to try to coherently combine the carriers. It is thus important to indicate to the UE if two carriers are coherent or not.

### BRIEF DESCRIPTION OF THE FIGURES

For a more complete understanding of the disclosed embodiments and their features and advantages, reference is now made to the following description, taken in conjunction with the accompanying drawings, in which:

FIG. 1 illustrates an example of Next Generation-Radio Access Network (NG-RAN) Release 15 location services (LCS) protocols.

FIG. 2 illustrates an example of multi-TRP in a cell.

FIG. 3 illustrates an example of simulation results showing the effect of inter-carrier phase difference on DL TDOA positioning in an Indoor Factory with Sparse clutter and High base station height (InF-SH) scenario.

FIG. 4 illustrates an example embodiment of indicating aggregated DL PRS to a wireless device (e.g., UE). FIG. 4 begins at FIG. 4a and continues to FIG. 4b.

FIG. 5 illustrates an example embodiment of indicating aggregated DL PRS to the UE at the frequency layer level. FIG. 5 begins at FIG. 5a and continues to FIG. 5b.

FIG. 6 illustrates an example embodiment of indicating aggregated DL PRS to the UE at the DL PRS resource set level. FIG. 6 begins at FIG. 6a and continues to FIG. 6b.

FIG. 7 illustrates a signaling sequence for PRS aggregation for DL-PRS based on LPP configuration, where “SgNB” denotes Serving gNB and “NgNB” denotes Neighbor gNB, in accordance with some embodiments.

FIG. 8 illustrates a signaling sequence for RRC-based configuration for PRS aggregation, where “SgNB” denotes Serving gNB and “NgNB” denotes Neighbor gNB, in accordance with some embodiments.

FIG. 9 illustrates a wireless network, in accordance with some embodiments.

FIG. 10 illustrates a User Equipment (UE), in accordance with some embodiments.

FIG. 11 illustrates a virtualization environment, in accordance with some embodiments.

FIG. 12 illustrates a telecommunication network connected via an intermediate network to a host computer, in accordance with some embodiments

FIG. 13 illustrates a host computer communicating via a base station with a user equipment over a partially wireless connection, in accordance with some embodiments.

FIG. 14 illustrates methods implemented in a communication system including a host computer, a base station, and a user equipment, in accordance with some embodiments.

FIG. 15 illustrates methods implemented in a communication system including a host computer, a base station, and a user equipment, in accordance with some embodiments.

FIG. 16 illustrates methods implemented in a communication system including a host computer, a base station, and a user equipment, in accordance with some embodiments.

FIG. 17 illustrates methods implemented in a communication system including a host computer, a base station, and a user equipment in accordance with some embodiments.

FIG. 18 illustrates a method implemented in a wireless device, such as a UE, in accordance with some embodiments.

FIG. 19 illustrates a virtualization apparatus, in accordance with some embodiments.

FIG. 20 illustrates an example of a method implemented in a wireless device, such as a UE, in accordance with some embodiments.

FIG. 21 illustrates an example of a method implemented in a network node, in accordance with some embodiments.

FIG. 22 illustrates an example of a method implemented in a radio network node, in accordance with some embodiments.

FIG. 23 illustrates an example of a method implemented in a location node, in accordance with some embodiments.

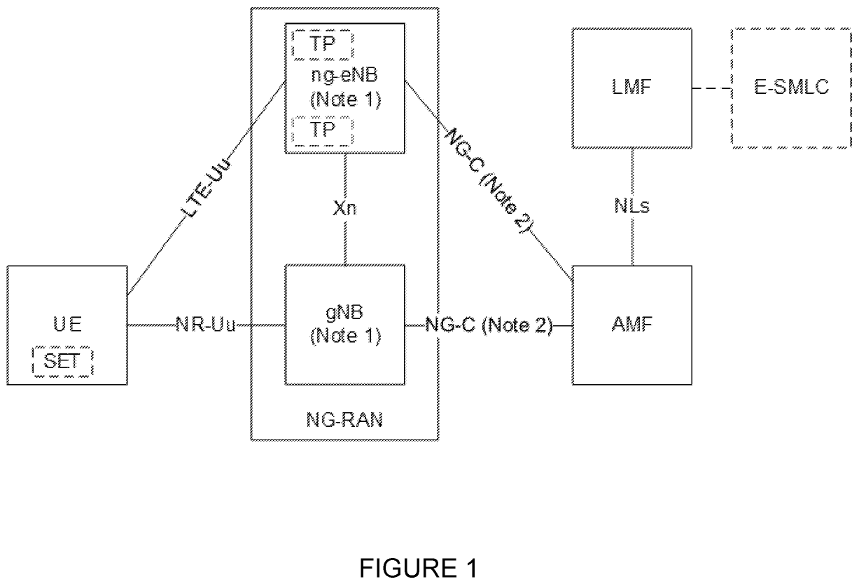

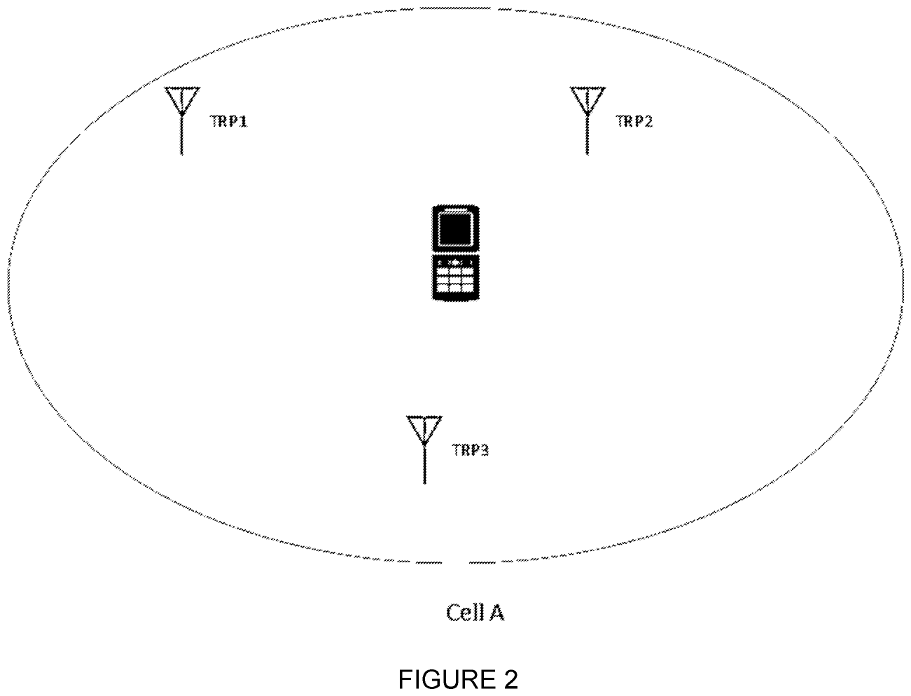

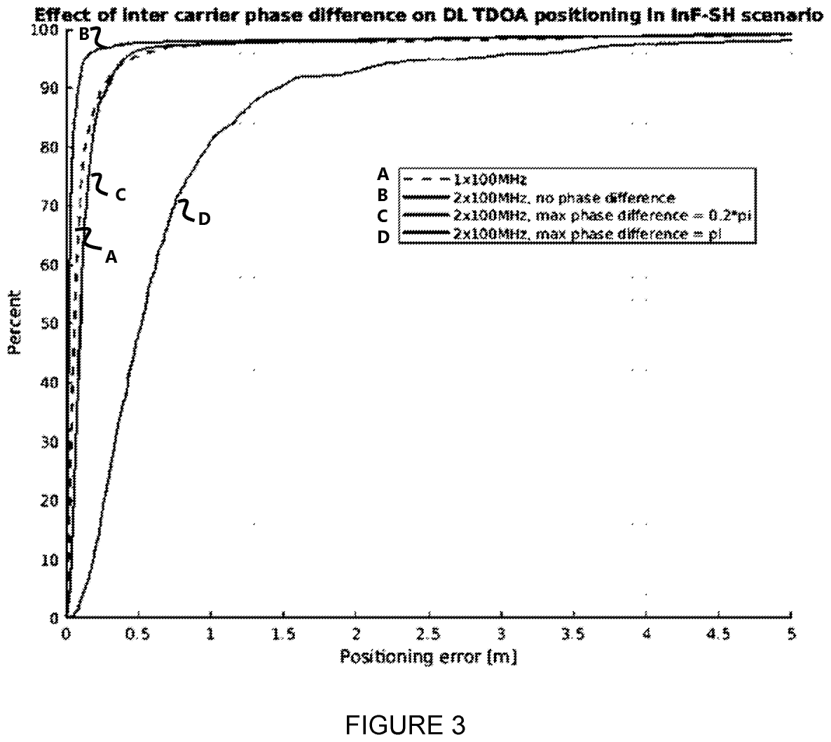

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Embodiment 1: Signaling Aggregated Downlink PRS to the UE

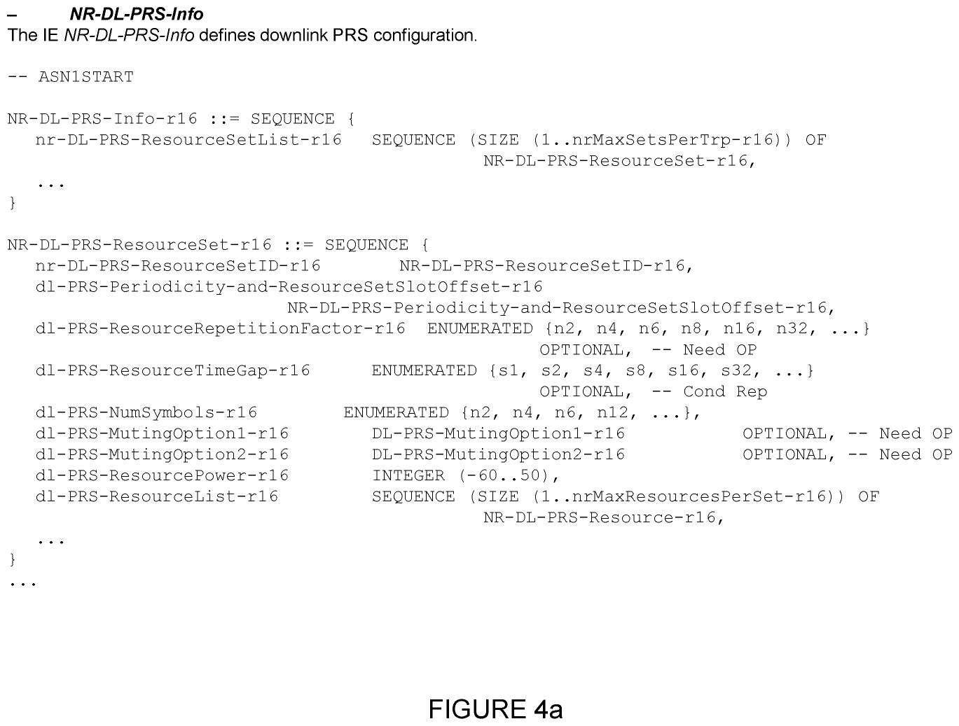

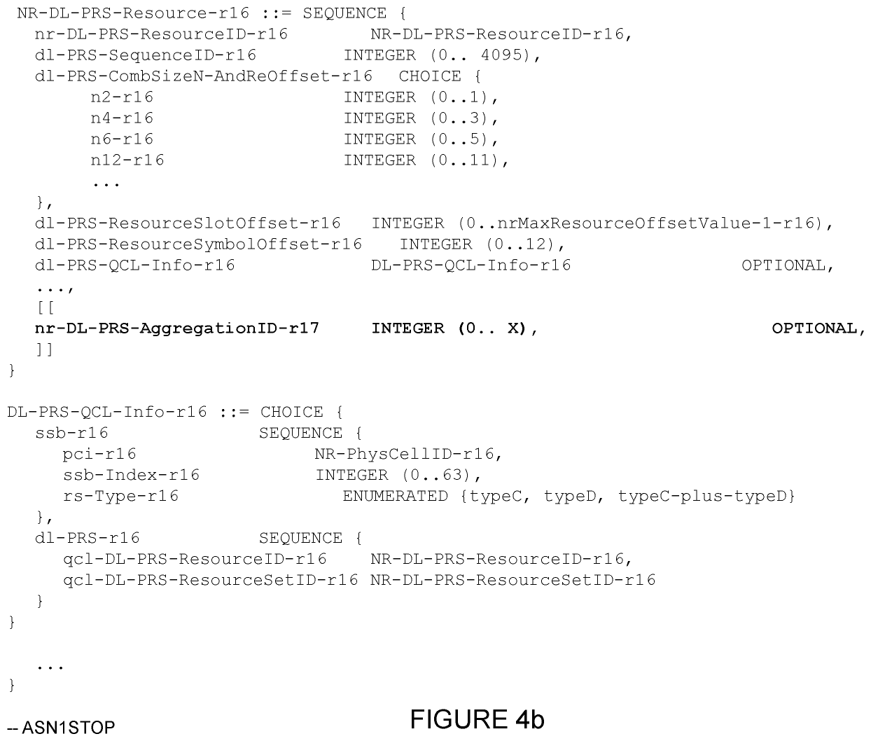

In one embodiment, the LMF indicates aggregated downlink (DL) PRS resources to the UE by including an index in the DL PRS resource configuration (e.g., an index nr-DL-PRS-AggregationlD-r17 as part of NR-DL-PRS-Resource) as shown in FIG. 4 (which begins at FIG. 4a and continues to FIG. 4b to illustrate a first example embodiment of indicating aggregated DL PRS to the UE). When two DL PRS resources are configured with the same nr-DL-PRS-AggregationlD-r17 index value, then the UE performs measurements and coherently/jointly processes the two DL PRS resources. In this sense, the index nr-DL-PRS-AggregationlD-r17 represents a group of DL PRS resources that can be measured and coherently/jointly processed. If the index nr-DL-PRS-AggregationlD-r17 is not present, the absence of the index indicates that the UE cannot assume that the corresponding DL PRS resources are transmitted coherently with any other configured DL PRS resources.

In some embodiments, the number of DL PRS resources that can be measured and coherently/jointly processed can be N where N≥2. That is, up to N DL PRS resources may have the same nr-DL-PRS-AggregationlD-r17 index value configured. In some embodiments, how many DL PRS resources a UE can measure and coherently/jointly process (i.e., the maximum value of N) is a UE capability that is reported by the UE to the gNB. In some other embodiments, the maximum value of N is fixed in 3GPP specifications.

The index nr-DL-PRS-AggregationlD-r17 is optional and may have an integer range between 0 and X (where X is an integer ≥1). The value of X hence determines the number of groups of DL PRS resources that can be measured and coherently/jointly processed (i.e., the number of groups is X+1). In some embodiments, the value of X is fixed in 3GPP specifications. In some other embodiments, X is a UE capability that is reported by the UE to the gNB. When a DL PRS resource does not have a nr-DL-PRS-AggregationlD-r17 index configured, then this DL PRS resource is not coherently/jointly processed with another DL PRS resource.

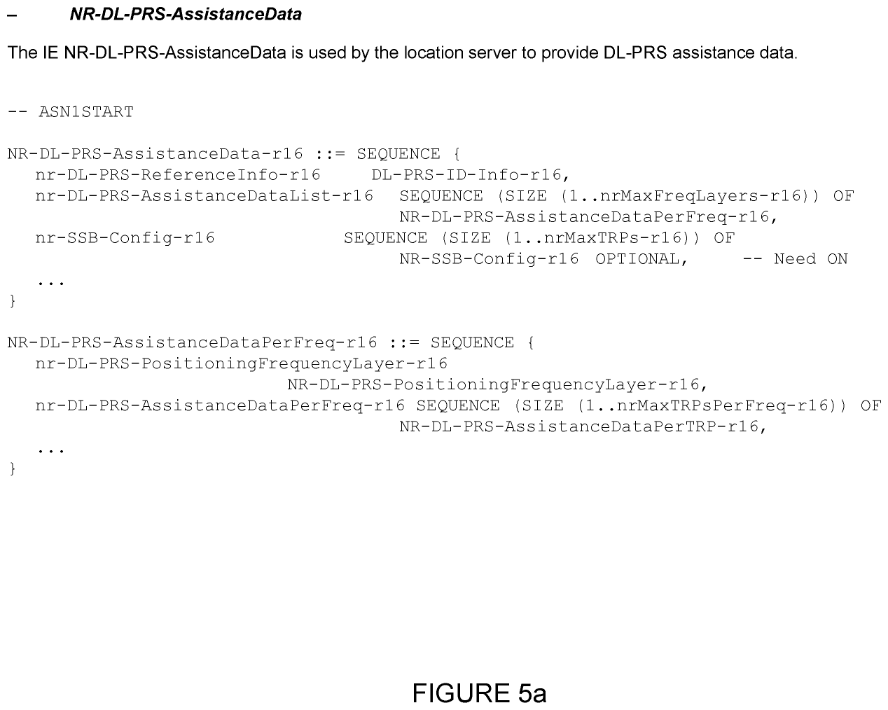

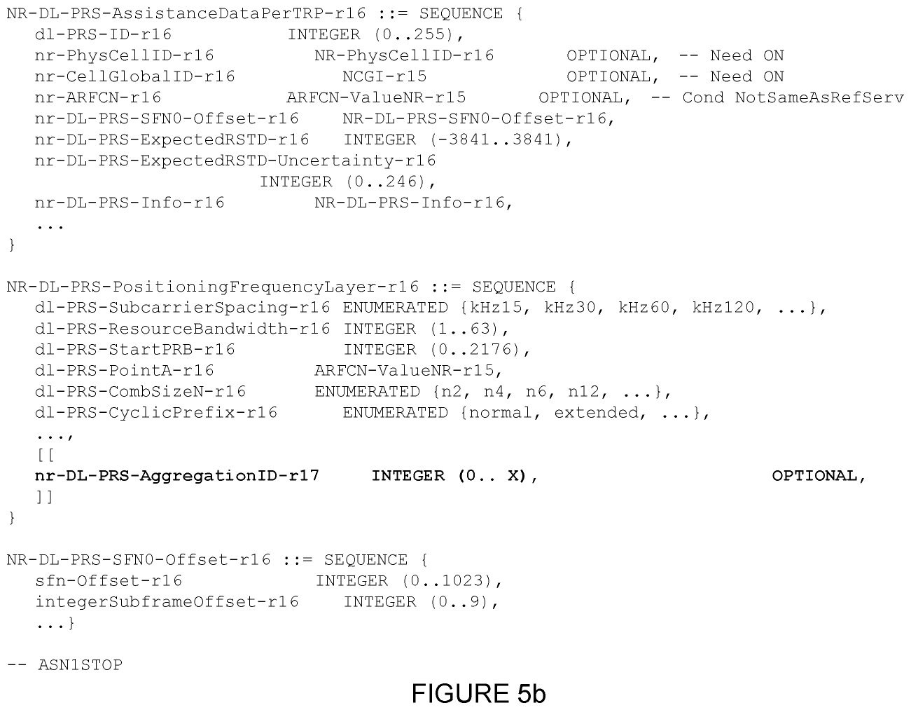

In an alternative embodiment, the index nr-DL-PRS-AggregationlD-r17 may be configured at the frequency layer level. For instance, the index nr-DL-PRS-AggregationlD-r17 may be configured in the NR-DL-PRS-PositioningFrequencyLayer-r16 field defined in [TS 37.355 V16.2.0]. The UE then jointly processes two DL PRS resources when they belong to two different frequency layers that have the same value of index nr-DL-PRS-AggregationlD-r17. In some embodiments, the N^{th} NR-DL-PRS-Resource-r16 in the dl-PRS-ResourceList-r16 of the M^{th} NR-DL-PRS-ResourceSet-r16 in the nr-DL-PRS-ResourceSetList-r16 for the TRP being measured in the NR-DL-PRS-AssistanceDataPerFreq-r16 with a given nr-DL-PRS-AggregationlD-r17 index shall only be coherently/jointly processed with the N^{th} NR-DL-PRS-Resource-r16 in the dl-PRS-ResourceList-r16 of the M^{th} NR-DL-PRS-ResourceSet-r16 in the nr-DL-PRS-ResourceSetList-r16 for the TRP being measured in the NR-DL-PRS-AssistanceDataPerFreq-r16 with the same nr-DL-PRS-AggregationlD-r17. FIG. 5 (which begins at FIG. 5a and continues to FIG. 5b) illustrates an example embodiment of indicating aggregated DL PRS to the UE at the frequency layer level.

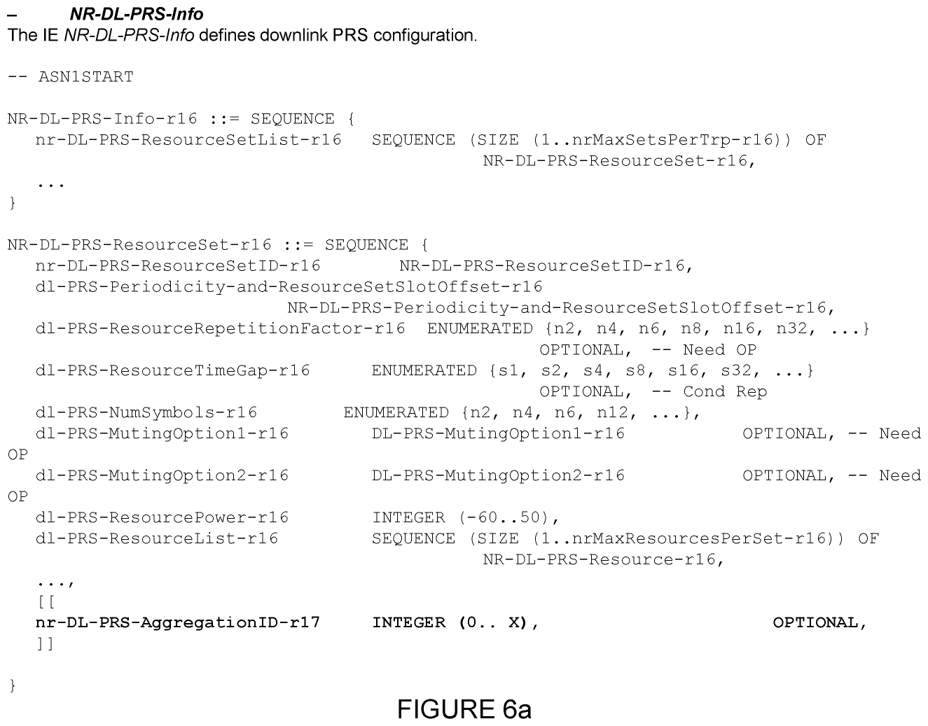

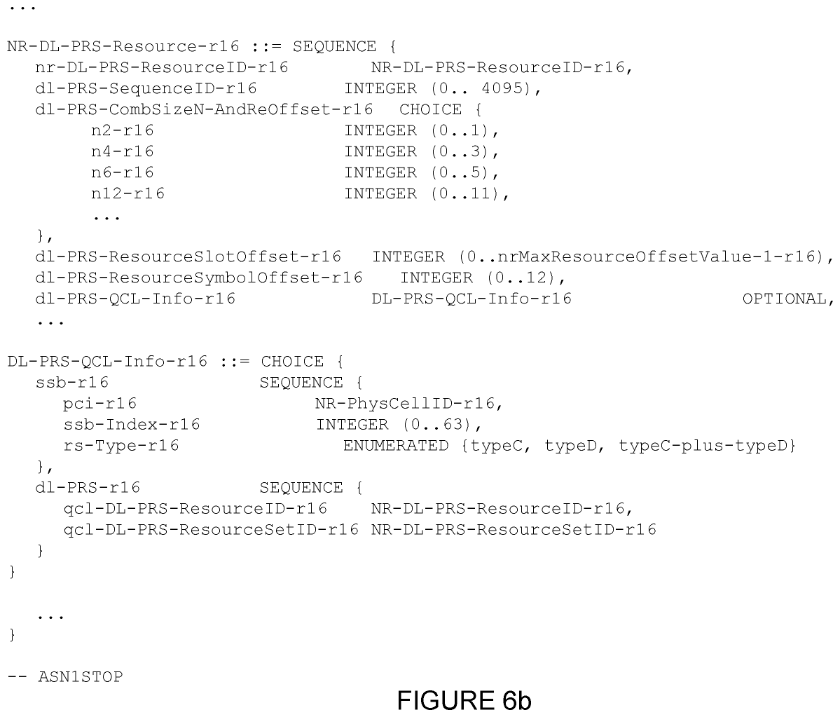

In yet another alternative embodiment, the index nr-DL-PRS-AggregationlD-r17 may be configured at the DL PRS resource set level. For instance, the index nr-DL-PRS-AggregationlD-r17 may be configured in the NR-DL-PRS-ResourceSet-r16 field. The UE then jointly processes two DL PRS resource when they belong to two different DL PRS resource sets that have the same value of index nr-DL-PRS-AggregationlD-r17. In some embodiments, in order for DL PRS resources from two different DL PRS resource sets to be coherently/jointly processed, the number of DL PRS resources in these two DL PRS resource sets need to be the same. In some embodiments, the N^{th} NR-DL-PRS-Resource-r16 in the dl-PRS-ResourceList-r16 of a NR-DL-PRS-ResourceSet-r16 with a given nr-DL-PRS-AggregationlD-r17 index shall only be coherently/jointly processed with the N^{th} NR-DL-PRS-Resource-r16 in the dl-PRS-ResourceList-r16 of other NR-DL-PRS-ResourceSet-r16 with the same nr-DL-PRS-AggregationlD-r17 index. FIG. 6 (which begins at FIG. 6a and continues to FIG. 6b) illustrates an example embodiment of indicating aggregated DL PRS to the UE at the DL PRS resource set level.

### Embodiment 2: Conditions for Coherently/Jointly Combining DL PRS Resources

In order for two or more DL PRS resources to be coherently/jointly processed certain conditions may need to be met. These conditions may include one or more of the following:
the two or more DL PRS resources must be transmitted from the same TRP. In NR Rel-16, the TRP is represented by dl-PRS-ID [TS 37.355 V16.2.0]. Hence, in one embodiment, two or more DL PRS resources can only be coherently/jointly processed if they correspond to the same dl-PRS-ID value.
the two or more DL PRS resources may need to be received by the UE in the same slot so that coherency holds which would allow the UE to coherently/jointly process these two or more DL PRS resources. Hence, in another embodiment, the two or more DL PRS resources may need to be received with the same periodicity and/or slot offset. This means that the dl-PRS-Periodicity-and-ResourceSetSlotOffset-r16 field given in the DL PRS resource sets (i.e., NR-DL-PRS-ResourceSet-r16's) corresponding to each of the two or more DL PRS resources need to have the same value. In some other embodiments, the two or more DL PRS resources to be coherently/jointly processed may need to have the same slot offset value defined in their DL PRS resource configurations (e.g., the dl-PRS-ResourceSlotOffset-r16 field values associated with these two or more DL PRS resources to be coherently/jointly processed may need to have the same value).
In some other embodiments, the two or more DL PRS resources to be coherently/jointly processed may need to be received by the UE in the same symbol so that coherency holds which would allow the UE to coherently/jointly process the two or more DL PRS resources. Hence, in these embodiments, the two more DL PRS resources to be coherently/jointly processed may need to have the same symbol offset value defined in their DL PRS resource configurations (e.g., the dl-PRS-ResourceSlotOffset-r16 field values associated with these two or more DL PRS resources to be coherently/jointly processed may need to have the same value).
In some other embodiments, the two or more DL PRS resources to be coherently/jointly processed may need to be limited to a single repetition. This means that the dl-PRS-ResourceRepetitionFactor-r16 field is not configured in the DL PRS resource sets (i.e., NR-DL-PRS-ResourceSet-r16's) corresponding to each of the two or more DL PRS resources. In an alternative embodiment, the two or more DL PRS resources to be coherently/jointly processed may need to be limited to a fixed maximum number of repetitions Mmax. In this alternative embodiment, the dl-PRS-ResourceRepetitionFactor-r16 field configured in the DL PRS resource sets (i.e., NR-DL-PRS-ResourceSet-r16's) corresponding to each of the two or more DL PRS resources need to have the same value which is less than or equal to Mmax.
In some other embodiments, the two or more DL PRS resources to be coherently/jointly processed may need to be received by the UE with the same QCL information (e.g., same beam or same QCL type D source reference signal). Hence, in these embodiments, the two more DL PRS resources to be coherently/jointly processed may need to have the same dl-PRS-QCL-Info-r16 parameters defined in their DL PRS resource configurations (e.g., the dl-PRS-QCL-Info-r16 field values associated with these two or more DL PRS resources to be coherently/jointly processed may need to have the same values of ssb-r16 or dl-PRS-r16).
In some other embodiments, the two or more DL PRS resource to be coherently/jointly processed may need to belong to different frequency layers. In some embodiments, one or more of the parameters within nr-DL-PRS-PositioningFrequencyLayer-r16 corresponding to the two or more DL PRS resources to be coherently/jointly processed may need to be different.
In some embodiments, the subcarrier spacing associated with the two or more DL PRS resource to be coherently/jointly processed may need to the same.

When one or more of the above conditions are not met, the UE does not coherently/jointly process the two or more DL PRS resources. In an alternative embodiment, when one or more of the above conditions are not met, the UE only processes one of the DL PRS resources among the two or more DL PRS resources configured to be aggregated (i.e., no coherent/joint processing is performed).

### Embodiment 3: Extensions to RRC Configured DL PRS and Other Reference Signals

Although Embodiments 1 and 2 above are written from the perspective of DL PRS resources being configured by the LMF to the UE via the LPP protocol, Embodiments 1 and 2 may be equally applicable when the DL PRS resources are RRC configured from the gNB to the UE. DL PRS resource being RRC configured is beneficial when multiple TRPs belong to the same serving cell and is thus controlled by the same gNB. Furthermore, parts or whole of Embodiments 1-2 are applicable when the DL PRS resources are aperiodic or semi-persistent. Aperiodic DL PRS here refers to an DL PRS that is higher layer configured and triggered by a field in downlink control information (DCI). Semi persistent DL PRS refers to a DL PRS that is higher layer configured and activated/deactivated via Medium Access Control (MAC) Control Element (CE).

Embodiments 1 and/or 2 may also be extended to other reference signals that are supported to be used for positioning measurements (e.g., non-zero-power (NZP) CSI-RS, tracking reference signal (TRS), etc.). For instance, an index may be configured in NZP CSI-RS resource or resource set to indicate whether one or more NZP CSI-RS resources may be coherently/jointly processed for positioning measurements.

### Embodiment 4: Indicating DL PRS Aggregation from NG-RAN Node to the LMF

In NR Rel-16, the LMF sends requests to NG-RAN node regarding information on TRPs hosted by the NG-RAN node via the ‘TRP INFORMATION REQUEST’ message [3GPP TS 38.455 V16.1.0]. In response, the NG-RAN node may provide the ‘TRP INFORMATION RESPONSE’ [3GPP TS 38.455 V16.1.0] which may contain information related to one or more TRPs hosted by the NG-RAN node. The ‘TRP Information’ information element which is part of the ‘TRP INFORMATION RESPONSE’ includes the PRS configuration.

Whether one or more DL PRS resources can be coherently transmitted by the TRP needs to be indicated to the LMF. Hence, in one embodiment, a PRS aggregation ID is included at the PRS Resource Set level as shown in Table 1. If two PRS resource sets have the same value of PRS aggregation ID, then two or more PRS in the two PRS resource sets can be coherently transmitted by the TRP. In some embodiments, the maximum value X of the PRS aggregation ID is fixed in specifications. The PRS Aggregation ID is an optional parameter, and if PRS Aggregation ID is not included for a particular PRS Resource set, then this implies that the PRS resources from this PRS resource set cannot be aggregated with PRS resources from other PRS resource sets.

TABLE 1
A first example of enhanced PRS Configuration information element in
TS 38.455 to indicate DL PRS aggregation from NG-RAN Node to the LMF

| | | | IE Type and | Semantics |
|---|---|---|---|---|
| IE/Group Name | Presence | Range | Reference | Description |
| PRS Resource Set | | 1 . . . | | |
| List | | <maxnoofPRSresourceSet> | | |
| >PRS Resource Set | M | | INTEGER(0 . . . 7) | |
| ID | | | | |
| >PRS Aggregation | O | | INTEGER(0 . . . X) | |
| ID | | | | |
| >Subcarrier Spacing | M | | ENUMERATED(kHz 15, | |
| | | | kHz 30, kHz 60, | |
| | | | kHz 120, . . .) | |
| >PRS bandwidth | M | | INTEGER(1 . . . 63) | 24, 28, . . . , 272 |
| | | | | PRBs |
| >Start PRB | M | | INTEGER(0 . . . 2176) | Starting PRB to |
| | | | | Point A |
| >Point A | M | | INTEGER | NR ARFCN |
| | | | (0 . . . 3279165) | |
| >Comb Size | M | | ENUMERATED(2, | |
| | | | 4, 6, 12, . . .) | |
| >CP Type | M | | ENUMERATED(normal, | |
| | | | extended, . . .) | |
| >Resource Set | M | | ENUMERATED(4, | |
| Periodicity | | | 5, 8, 10, 16, 20, 32, | |
| | | | 40, 64, 80, 160, 320, | |
| | | | 640, 1280, 2560, 5120, | |
| | | | 10240, 20480, 40960, | |
| | | | 81920, . . .) | |
| >Resource Set Slot | M | | INTEGER(0 . . . 81919, | |
| Offset | | | . . .) | |
| >Resource Repetition | M | | ENUMERATED(rf1, rf2, | |
| Factor | | | rf4, rf6, rf8, rf16, | |
| | | | rf32, . . .) | |
| >Resource Time Gap | M | | ENUMERATED(tg1, tg2, | |
| | | | tg4, tg8, tg16, tg32, | |
| | | | . . .) | |
| >Resource Number | M | | ENUMERATED(n2, n4, | |
| of Symbols | | | n6, n12, . . .) | |
| >PRS Muting | O | | | |
| >>Option 1 | O | | | |
| >>>Muting | M | | 9.2.56 | |
| Pattern | | | | |
| >>>Muting Bit | M | | ENUMERATED(1, 2, | |
| Repetition Factor | | | 4, 8, . . .) | |
| >>Option2 | O | | | |
| >>>Muting | M | | DL-PRS Muting | |
| Pattern | | | Pattern | |
| | | | 9.2.56 | |
| >PRS Resource | M | | INTEGER(−60 . . . 50) | |
| Transmit Power | | | | |
| >PRS Resource List | M | 1 . . . | | |
| | | <maxnoofPRSresources> | | |
| >>PRS Resource | M | | INTEGER(0 . . . 63) | |
| ID | | | | |
| >>Sequence ID | M | | INTEGER(0 . . . 4095, | |
| | | | . . .) | |
| >>RE Offset | M | | INTEGER(0 . . . 11) | |
| >>Resource Slot | M | | INTEGER(0 . . . 511, | |
| Offset | | | . . .) | |
| >>Resource | M | | INTEGER(0 . . . 12, | |
| Symbol Offset | | | . . .) | |
| >>QCL Info | O | | | |
| >>>QCL Source | O | | INTEGER(0 . . . 63) | |
| SSB Index | | | | |
| >>>QCL Source | O | | | |
| PRS Info | | | | |
| >>>>QCL | M | | INTEGER(0 . . . 7) | |
| Source PRS | | | | |
| Resource Set ID | | | | |
| >>>>QCL | O | | INTEGER(0 . . . 63) | If it is absent, the |
| Source PRS | | | | QCL source PRS |
| Resource ID | | | | resource ID is the |
| | | | | same as the PRS |
| | | | | resource ID |

In an alternative embodiment, a PRS aggregation ID is included at the PRS Resource level as shown in Table 2. If two PRS resources have the same value of PRS aggregation ID, then these two PRS resources can be coherently transmitted by the TRP. In some embodiments, the maximum value X of the PRS aggregation ID is fixed in specifications. The PRS Aggregation ID is an optional parameter, and if PRS Aggregation ID is not included for a particular PRS Resource, then this implies that this PRS resource cannot be aggregated with other PRS resources.

The LMF takes into account the PRS aggregation information provided in this embodiment when configuring the DL PRS to the UE via LPP protocol.

TABLE 2
A second example of enhanced PRS Configuration information element in
TS 38.455 to indicate DL PRS aggregation from NG-RAN Node to the LMF

| | | | IE Type and | Semantics |
|---|---|---|---|---|
| IE/Group Name | Presence | Range | Reference | Description |
| PRS Resource Set | | 1 . . . | | |
| List | | <maxnoofPRSresourceSet> | | |
| >PRS Resource Set | M | | INTEGER(0 . . . 7) | |
| ID | | | | |
| >Subcarrier Spacing | M | | ENUMERATED(kHz 15, | |
| | | | kHz 30, kHz 60, | |
| | | | kHz 120, . . . ) | |
| >PRS bandwidth | M | | INTEGER(1 . . . 63) | 24, 28, . . . , |
| | | | | 272 PRBs |
| >Start PRB | M | | INTEGER(0 . . . 2176) | Starting PRB to |
| | | | | Point A |
| >Point A | M | | INTEGER | NR ARFCN |
| | | | (0 . . . 3279165) | |
| >Comb Size | M | | ENUMERATED(2, | |
| | | | 4, 6, 12, . . .) | |
| >CP Type | M | | ENUMERATED(normal, | |
| | | | extended, . . .) | |
| >Resource Set | M | | ENUMERATED(4, | |
| Periodicity | | | 5, 8, 10, 16, 20, 32, 40, | |
| | | | 64, 80, 160, 320, 640, 1280, | |
| | | | 2560, 5120, 10240, 20480, | |
| | | | 40960, 81920, . . .) | |
| >Resource Set Slot | M | | INTEGER(0 . . . 81919, | |
| Offset | | | . . .) | |
| >Resource Repetition | M | | ENUMERATED(rf1, rf2, | |
| Factor | | | rf4, rf6, rf8, rf16, | |
| | | | rf32, . . .) | |
| >Resource Time Gap | M | | ENUMERATED(tg1, tg2, | |
| | | | tg4, tg8, | |
| | | | tg16, tg32, . . .) | |
| >Resource Number | M | | ENUMERATED(n2, n4, | |
| of Symbols | | | n6, n12, . . .) | |
| >PRS Muting | O | | | |
| >>Option 1 | O | | | |
| >>>Muting | M | | 9.2.56 | |
| Pattern | | | | |
| >>>Muting Bit | M | | ENUMERATED(1, 2, | |
| Repetition Factor | | | 4, 8, . . .) | |
| >>Option2 | O | | | |
| >>>Muting | M | | DL-PRS Muting | |
| Pattern | | | Pattern | |
| | | | 9.2.56 | |
| >PRS Resource | M | | INTEGER(−60 . . . 50) | |
| Transmit Power | | | | |
| >PRS Resource List | M | 1 . . . | | |
| | | <maxnoofPRSresources> | | |
| >>PRS Resource | M | | INTEGER(0 . . . 63) | |
| ID | | | | |
| >PRS Aggregation | O | | INTEGER(0 . . . X) | |
| ID | | | | |
| >>Sequence ID | M | | INTEGER(0 . . . 4095, | |
| | | | . . .) | |
| >>RE Offset | M | | INTEGER(0 . . . 11) | |
| >>Resource Slot | M | | INTEGER(0 . . . 511, | |
| Offset | | | . . .) | |
| >>Resource | M | | INTEGER(0 . . . 12, | |
| Symbol Offset | | | . . .) | |
| >>QCL Info | O | | | |
| >>>QCL Source | O | | INTEGER(0 . . . 63) | |
| SSB Index | | | | |
| >>>QCL Source | O | | | |
| PRS Info | | | | |
| >>>>QCL | M | | INTEGER(0 . . . 7) | |
| Source PRS | | | | |
| Resource Set ID | | | | |
| >>>>QCL | O | | INTEGER(0 . . . 63) | If it is absent, the |
| Source PRS | | | | QCL source PRS |
| Resource ID | | | | resource ID is the |
| | | | | same as the PRS |
| | | | | resource ID |

### Embodiment 5: Indicating Cell Based DL PRS Aggregation

In this embodiment, each gNB configures for data communication a primary serving cell and secondary cell(s) for multicarrier operation. The gNB/Operations, Administration and Maintenance (OAM) may record the multicarrier combination that was used for data communication and this could be relayed to LMF. OAM may configure or select the same carriers (serving cell and secondary cells) for PRS aggregated transmission. This information is relayed to LMF via NRPPa or by OAM means. An example indication of carrier aggregated PRS is shown in Table 3.

TABLE 3
A third example to indicate carrier aggregated PRS in TS
38.455 to indicate DL PRS from NG-RAN Node to the LMF

| | | | IE Type and | |
|---|---|---|---|---|
| IE/Group Name | Presence | Range | Reference | Description |
| Carrier Aggregated | | 1 | | |
| List | | | | |
| >CA from Primary | | 1 . . . | | |
| Serving cell List | | <maxnooPrimaryServingCell> | | |
| >>TRP ID Primary | O | | INTEGER | Maximum no. of |
| Cell | | | (1 . . . maxnoTRP) | TRPs in a NG- |
| | | | | RAN node. Value |
| | | | | is 65535. |
| >>Primary Serving | M | | INTEGER | If TRP ID is not |
| Cell ID | | | (0 . . . 1007) | present; instead of |
| | | | | Physciall Cell ID a |
| | | | | global identifier |
| | | | | could be used |
| >>NCGI Serving | O | | NG-RAN CGI | |
| Cell ID | | | | |
| >CA from Secondary | | 1 . . . | | |
| Serving cell Item | | <maxnooSecondaryCells> | | |
| >>TRP ID | O | | INTEGER | Maximum no. of |
| Secondary cell | | | (1 . . . maxnoTRP) | TRPs in a NG- |
| | | | | RAN node. Value |
| | | | | is 65535. |
| >>Secondary Serving | M | | INTEGER | If TRP ID is not |
| Cell ID | | | (0 . . . 1007) | present; instead of |
| | | | | Physciall Cell ID a |
| | | | | global identifier |
| | | | | could be used |
| >>NCGI Secondary | O | | NG-RAN NCGI | |
| Serving Cell ID | | | | |

When LMF prepares assistance data to the UE (LPP), it will take this input into account and configure the UE to perform PRS measurement coherently/jointly with wide-bandwidth (aggregated bandwidth).

An example LPP information element for indicating ‘nr-DL-PRS-CarrierAggregationInfo-r17’ along with the field description is provided below:

-- ASN1START
NR-DL-PRS-AssistanceData-r16 ::=SEQUENCE {

| | |
|---|---|
| nr-DL-PRS-ReferenceInfo-r16 | DL-PRS-ID-Info-r16, |

nr-DL-PRS-AssistanceDataList-r16SEQUENCE (SIZE (1..nrMaxFreqLayers-r16)) OF

| | |
|---|---|
| | NR-DL-PRS-AssistanceDataPerFreq- |
| r16, | |
| nr-SSB-Config-r16 | SEQUENCE (SIZE (1..nrMAxTRPs-r16)) OF |
| | NR-SSB-Config-r16 OPTIONAL, -- Need ON |
| ... | |
| } | |

NR-DL-PRS-AssistanceDataPerFreq-r16 ::= SEQUENCE {
nr-DL-PRS-PositioningFrequencyLayer-r16

NR-DL-PRS-PositioningFrequencyLayer-r16,

nr-DL-PRS-AssistanceDataPerFreq-r16 SEQUENCE (SIZE (1..nrMaxTRPsPerFreq-
r16)) OF

| | |
|---|---|
| | NR-DL-PRS-AssitanceDataPerTRP- |
| r16, | |
| ... | |
| } | |

NR-DL-PRS-AssistanceDataPerTRP-r16 ::= SEQUENCE{

| dl-PRS-ID-r16 | INTEGER (0..255), | |
|---|---|---|
| nr-PhysCellID-r16 | NR-PhysCellID-r16 | OPTIONAL, -- Need |
| ON | | |
| nr-CellGlobalID-r16 | NCGI-r15 | OPTIONAL, -- Need |
| ON | | |
| nr-ARFCN-r16 | ARFCN-ValueNR-r15 | OPTIONAL, -- Cond |
| NotSameAsRefServ | | |
| nr-DL-PRS-SFN0-Offset-r16 | NR-DL-PRS-SFN0-Offset-r16, | |
| nr-DL-PRS-ExpectedRSTD-r16 | INTEGER (−3841..3841), | |
| nr-DL-PRS-ExpectedRSTD-Uncertainty-r16 | | |
| | INTEGER (0..246), | |
| nr-DL-PRS-Info-r16 | NR-DL-PRS-Info-r16, | |
| ..., | | |
| [[ | | |

| | |
|---|---|
| nr-DL-PRS-CarrierAggregationInfo-r17 | NR-DL-PRS-CarrierAggregationInfo-r17 |
| OPTIONAL | |
| ]] | |
| } | |

NR-DL-PRS-PositioningFrequencyLayer-r16 ::= SEQUENCE {
dl-PRS-SubcarrierSpacing-r16 ENUMERATED {kHz15, kHz30, kHz60, kHz120, ...}

| | |
|---|---|
| dl-PRS-ResourceBandwidth-r16 | INTEGER (1..63), |
| dl-PRS-StartPRB-r16 | INTEGER (0..2176), |
| dl-PRS-PointA-r16 | ARFCN-ValueNR-r15, |
| dl-PRS-CombSizeN-r16 | ENUMERATED {n2, n4, n6, n12, ...}, |
| dl-PRS-CyclicPrefix-r16 | ENUMERATED {normal, extended, ...}, |
| ... | |
| } | |

NR-DL-PRS-SFN0-Offset-r16 ::= SEQUENCE {

| | |
|---|---|
| sfn-Offset-r16 | INTEGER (0..1023), |
| integerSubframeOffset-r16 | INTEGER (0..9), |
| ...} | |

NR-DL-PRS-CarrierAggregationInfo-r17 ::= SEQUENCE {

| | |
|---|---|
| dl-PRS-ID-r16 | INTEGER (0..255), OPTIONAL, |
| nr-SecondaryCellInfoist-r17 | NR-SecondaryCellInfoList-r17 OPTIONAL, -- Need ON |
| ... | |
| } | |

NR-SecondaryCellInfoList ::= SEQUENCE (SIZE (1..nrMaxSecondaryCells-r17)) OF NR-

SecondaryCellInfo-r17

NR-SecondaryCellInfo-r17 ::= SEQUENCE {

| nr-SecondaryCellId-r17 | NR-PhysCellID-r16 | |
|---|---|---|
| nr-SecondaryCellGlobalID-r17 | NCGI-r15 | OPTIONAL, -- |
| Need ON | | |

| | |
|---|---|
| nr-ARFCN-r17 | ARFCN-ValueNR-r15 OPTIONAL, -- Cond |
| NotSameAsRefServ | |
| nr-DL-PRS-SFN0-Offset-r17 | NR-DL-PRS-SFN0-Offset-r16, |
| nr-DL-PRS-AggregatedExpectedRSTD-r17 | INTEGER (−3841..3841), |

nr-DL-PRS-AggregatedExpectedRSTD-Uncertainty-r17 INTEGER (0..246),

| | |
|---|---|
| nr-DL-PPRS-SecondaryCellInfo-r17 | NR-DL-PRS-Info |
| r-16, | |
| ... | |
| } | |
| -- ASN1STOP | |

NR-SecondaryCellInfo field descriptions

nr-SecondaryCellID
This field specifies the physical cell identity of the secondary Cell/TRP.
nr-SecondaryCellGlobalID
This field specifies the NCGI, the globally unique identity of a cell in NR, as defined in TS
38.331 [35].
nr-ARFCN
This field specifies the NR-ARFCN of the TRP.

NR-SecondaryCellInfo field descriptions

nr-DL-PRS-SFN0-Offset
This field specifies the time offset of the SFN#0 slot#0 for the given TRP with respect to
SFN#0 slot#0 of the assistance data reference TRP and comprises the following subfields:
sfn-Offset specifies the System Frame Number (SFN) offset at the TRP antenna
location between the assistance data reference TRP and this neighbour TRP.
The offset corresponds to the number of full radio frames counted from the beginning
of a radio frame #0 of the assistance data reference TRP to the beginning of the closest
subsequent radio frame #0 of this neighbour TRP.
integerSubframeOffset specifies the frame boundary offset at the TRP antenna location
between the assistance data reference TRP and this neighbour TRP counted in full
subframes.
The offset is counted from the beginning of a subframe #0 of the assistance data
reference TRP to the beginning of the closest subsequent subframe #0 of this neighbour
TRP, rounded down to multiples of subframes.
nr-DL-PRS-AggregatedExpectedRSTD
This field indicates the RSTD value that the target device is expected to measure between the
reference TRP and the assistance data secondary cells/TRPs. The value is aggregated or
calculated based upon wide bandwidth (aggregation)
nr-DL-PRS-AggregatedExpectedRSTD-Uncertainty
This is aggregated value and hence it is expected that this value would be lower or better
approximated then the current without aggregation.
nr-DL-PRS-Info
This field specifies the PRS configuration of the secondary TRP/Cell.

Further it is possible for gNB to broadcast the PRS aggregation options to the UE. Basically, to encapsulate the Table 3 for the serving cell; and provide the aggregated PRS options (which secondary cells can be combined) via System Information Broadcast.

If UE happens to perform the measurement based upon both non-aggregated and aggregated PRS; the result could be provided as below. Otherwise, the UE while reporting; provides the result separately for each measurement performed based upon carrier aggregation.

-- ASN1START
NR-DL-TDOA-SignalMeasurementInformation-r16 ::= SEQUENCE {

| | |
|---|---|
| dl-PRS-ReferenceInfo-r16 | DL-PRS-ID-Info-r16, |
| nr-DL-TDOA-MeasList-r16 | NR-DL-TDOA-MeasList-r16, |
| ... | |
| } | |

NR-DL-TDOA-MeasList-r16 ::= SEQUENCE (SIZE(1..nrMaxTRPs-r16)) OF NR-DL-

TDOA-MeasElement-r16

NR-DL-TDOA-MeasElement-r16 ::= SEQUENCE {

| dl-PRS-ID-r16 | INTEGER (0..255), | |
|---|---|---|
| nr-PhysCellID-r16 | NR-PhysCellID-r16 | |
| OPTIONAL, | | |
| nr-CellGlobalID-r16 | NCGI-r15 | |
| OPTIONAL, | | |
| nr-ARFCN-r16 | ARFCN-ValueNR-r15 | |
| OPTIONAL, | | |
| nr-DL-PRS-ResourceID-r16 | NR-DL-PRS-RespurceID-r16 | |
| OPTIONAL, | | |
| nr-DL-PRS-ResourceSetID-r16 | NR-DL-PRS-ResourceSetID-r16 | OPTIONAL, |
| nr-TimeStamp-r16 | NR-TimeStamp-r16, | |
| nr-RSTD-r16 | CHOICE { | |
| k0-r16 | INTEGER (0..1970049), | |
| k1-r16 | INTEGER (0..985025), | |
| k2-r16 | INTEGER (0..492513), | |
| k3-r16 | INTEGER (0..246257), | |
| k4-r16 | INTEGER (0..123129), | |
| k5-r16 | INTEGER (0..61565), | |
| ... | | |
| }, | | |
| nr-AdditionalPathList-r16 | NR-AdditionalPathList-r16 | |
| OPTIONAL, | | |
| nr-TimingQuality-r16 | NR-TimingQuality-r16, | |
| nr-DL-PRS-RSRP-Result-r16 | INTEGER (0..126) | |
| OPTIONAL, | | |
| nr-DL-TDOA-AdditionalMeasurements-r16 | | |
| | NR-DL-TDOA-AdditionalMeasurements-r16 | |
| OPTIONAL, | | |
| ..., | | |
| [[ | | |
| nr-AggregatedPRS-RSTD-r16 | CHOICE { | |
| k0-r17 | INTEGER (0..1970049), | |
| k1-r17 | INTEGER (0..985025), | |
| k2-r17 | INTEGER (0..492513), | |
| k3-r17 | INTEGER (0..246257), | |
| k4-r17 | INTEGER 0..123129), | |
| k5-r17 | INTEGER (0..61565), | |
| ... | | |
| }, | OPTIONAL, | |
| nr-SecondaryCellList-r17 | NR-SecondaryCellList-r17 | // Represents the |
| secondary cell/TRP where UE performed aggregated measurements | | |
| ]] | | |
| } | | |

NR-DL-TDOA-AdditionalMeasurements-r16 ::= SEQUENCE (SIZE (1..3)) OF

| | |
|---|---|
| | NR-DL-TDOA- |
| AdditionalMeasurementsElement-r16 | |

NR-DL-TDOA-AdditionalMeasurementElement-r16 ::= SEQUENCE {

| | |
|---|---|
| nr-DL-PRS-ResourceID-r16 | NR-DL-PRS-ResourceID-r16 |
| OPTIONAL, | |
| nr-DL-PRS-ResourceSetID-r16 | NR-DL-PRS-ResourceSetID-r16 |
| OPTIONAL, | |
| nr-TimeStamp-r16 | NR-TimeStamp-r16, |
| nr-RSTD-ResultDiff-r16 | CHOICE { |
| k0-r16 | INTEGER (0..8191), |
| k1-r16 | INTEGER (0..4095), |
| k2-r16 | INTEGER (0..2047), |
| k3-r16 | INTEGER (0..1023), |
| k4-r16 | INTEGER (0..511), |
| k5-r16 | INTEGER (0..255), |
| ... | |
| }, | |
| nr-TimingQuality-r16 | NR-TimingQuality-r16, |
| nr-DL-PRS-RSRP-ResultDiff-r16 | INTEGER (0..61) |
| OPTIONAL, | |
| nr-AdditionalPathList-r16 | NR-AdditionalPathList-r16 |
| OPTIONAL, | |
| ... | |
| } | |
| -- ASN1STOP | |

### Signaling Sequence for PRS Aggregation

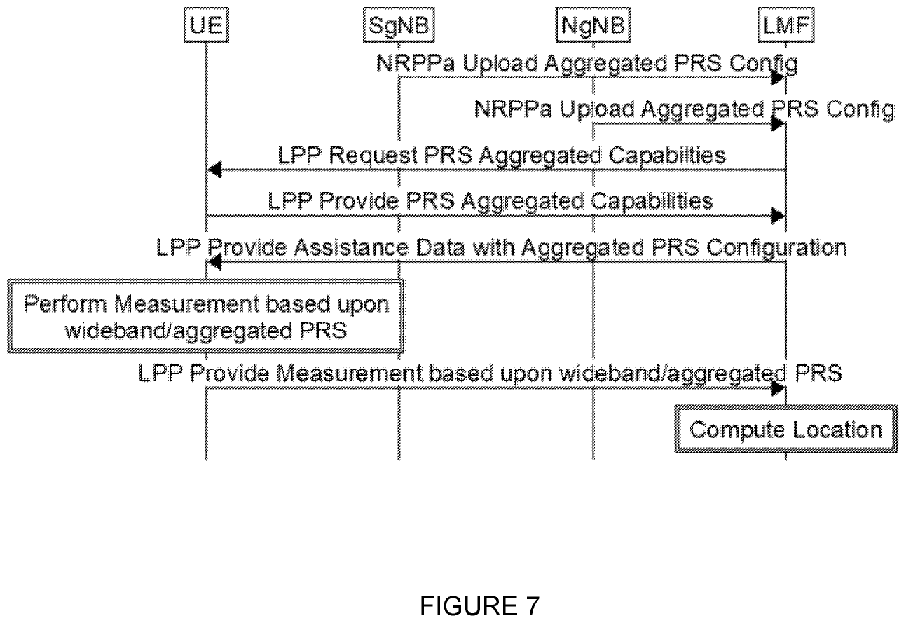

The signaling sequence for PRS aggregation for DL-PRS based on LPP configuration is shown in FIG. 7 (e.g., signaling sequence for PRS aggregation for DL-PRS based on LPP configuration where SgNB denotes Serving gNB and NgNB denotes Neighbor gNB). The signaling flow in FIG. 7 contains the following steps:
Base station (either SgNB or NgNB) provides the configuration to LMF which can enable aggregated PRS configuration via NRPPa or OAM.
LMF obtains UE capabilities related to aggregated PRS (e.g., wideband measurements support, supported band combinations, number of carrier aggregations supported)
LMF Provides the aggregated PRS configuration to UE in assistance data
UE performs the measurement based upon wideband/aggregated PRS configuration
UE provides the result based upon wideband/aggregated PRS configuration to the LMF
LMF computes the location.

The above steps may include one or more of the embodiments covered above in this disclosure.

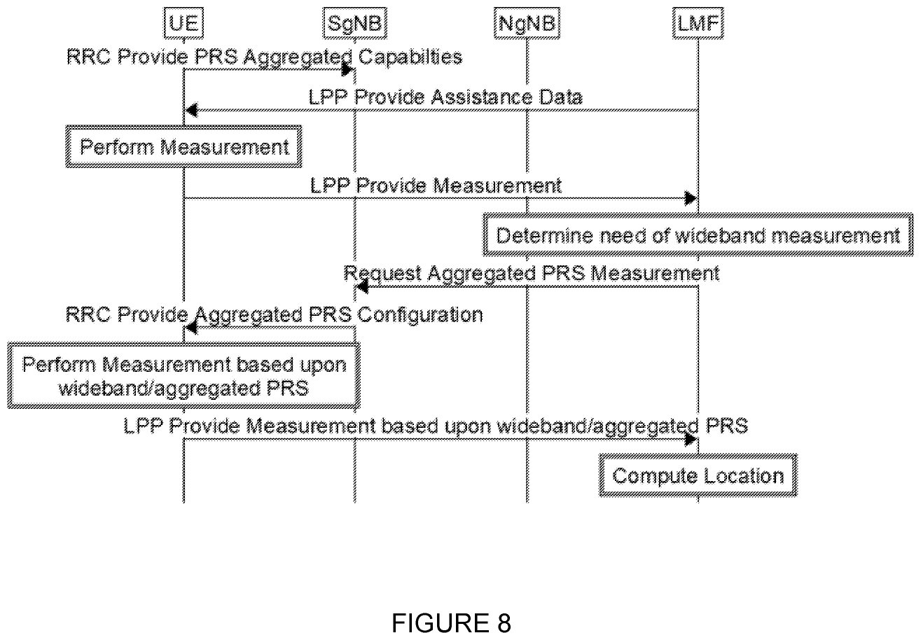

The signaling sequence for RRC based configuration for PRS aggregation is shown in FIG. 8 (e.g., signaling sequence for RRC based configuration for PRS aggregation where SgNB denotes Serving gNB and NgNB denotes Neighbor gNB). CSI-RS or any other reference signal which is configured by gNB may also be used for positioning purpose. In such case, the sequence is depicted in FIG. 8. The main difference being that RRC provides the aggregated CSI-RS configuration. Here a combination of LPP and RRC configuration is shown. It is possible to have all the configuration based upon RRC. Thus, LMF would only provide the recommendations based upon measurement results obtained from the UE via LPP. The signaling flow in FIG. 8 the following steps:
UE provides the PRS aggregated capabilities to serving gNB
LMF configures non-aggregated PRS configuration
LMF determines the need of wideband measurement and requests to gNB
gNB configures the wideband (aggregated) PRS (CSI-RS) configuration
UE performs the wideband measurements
UE provides the result based upon wideband measurement to the LMF
LMF computes the location

In summary, certain embodiments of the present disclosure provide signaling of Aggregated DL PRS resources that can be coherently/jointly processed from the LMF or the serving gNB to the UE. Examples of signaling details include the signaling details in Embodiment 1 (e.g., independent from the signaling details in Embodiment 5) and the signaling details in Embodiment 5 (e.g., independent from the signaling details in Embodiment 1. For the signaling methods in Embodiment 1, certain conditions may need to be met for coherently/jointly combining DL PRS resources, such as some or all of the conditions described in Embodiment 2. Certain embodiments of the present disclosure provide signaling of Aggregated DL PRS resources from serving or neighbor gNBs to the LMF, an example of which is described with respect to the signaling details in Embodiment 4.

Certain embodiments may relate to one or more of the following technology areas: positioning, New Radio (NR), Long Term Evolution (LTE), Channel Impulse Response (CIR), Time of Arrival (TOA), physical layer, and/or LTE positioning protocol (LPP). Certain embodiments may be implemented in one or more of the following 3GPP standards: TS 37.355, TS 38.455, TS 38.214, and/or NR Rel-17 (e.g., positioning study item/work item).

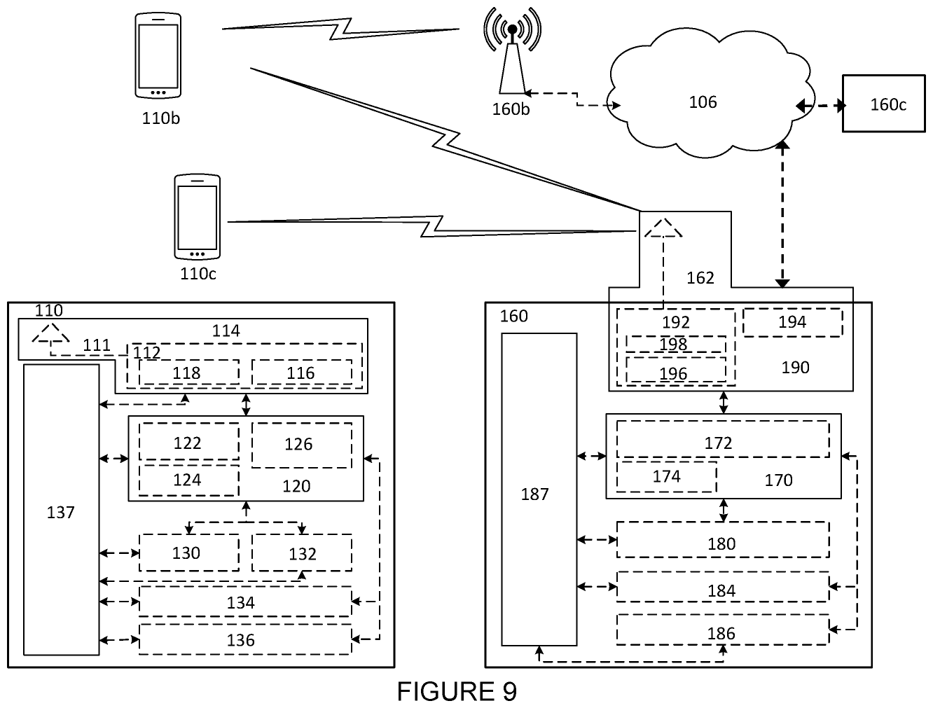

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Centers (MSCs), Mobility Management Entities (MMEs)), Operation and Maintenance (O&M) nodes, Operations Support System (OSS) nodes, Self-Optimized Network (SON) nodes, positioning nodes (e.g., E-SMLCs), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, Global System for Mobile communication (GSM), Wide Code Division Multiplexing Access (WCDMA), LTE, New Radio (NR), WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 9 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

The example illustrated in FIG. 9 includes network node 160c, which may be configured as a location node (such as a location server or LMF). Network node 160c may comprise any suitable circuitry of a network node 160, such as processing circuitry 170, power circuitry 187, and/or other circuitry that facilitates the functionality of a location node. Network node 160c may omit certain circuitry. For example, in embodiments of network node 160c that use wired connections, network node 160c need not include radio front end circuitry 192, RF transceiver circuitry 172, antenna 162, or other wireless-related circuitry.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

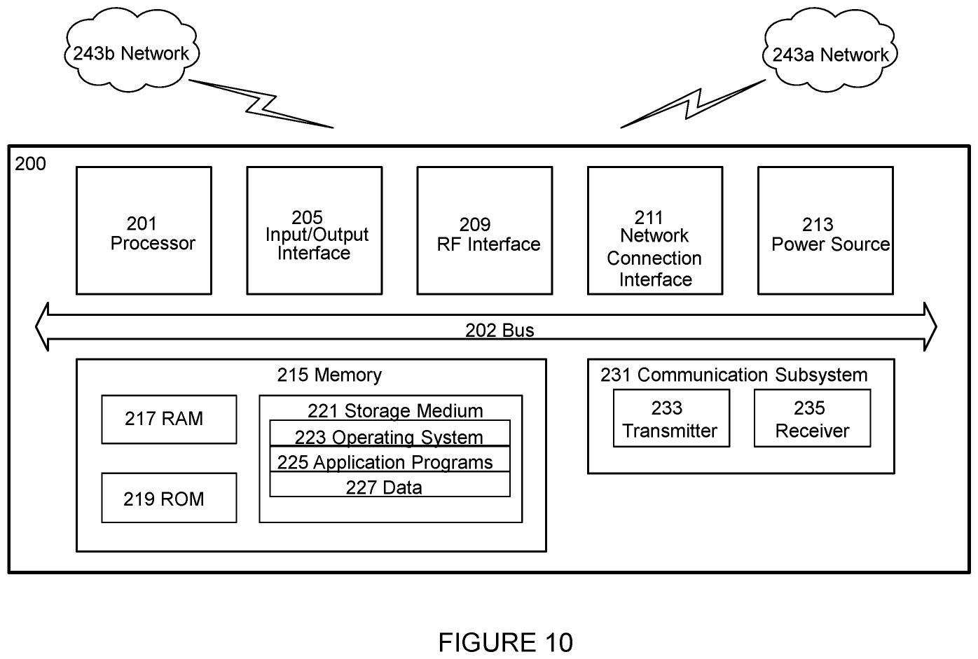

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, Universal Terrestrial Radio Access Network (UTRAN), WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

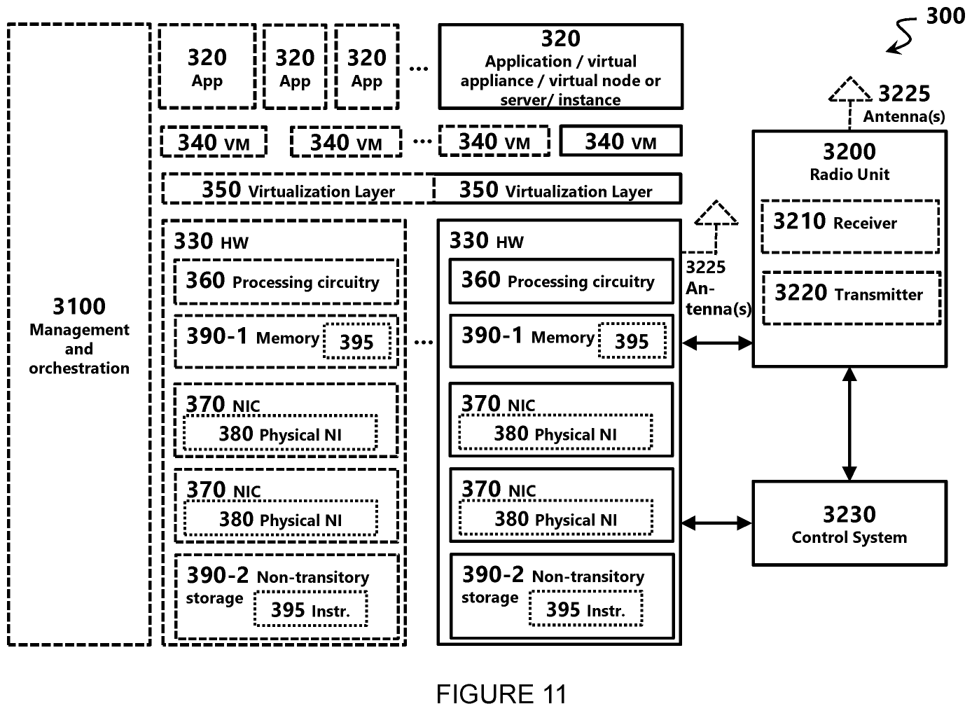

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

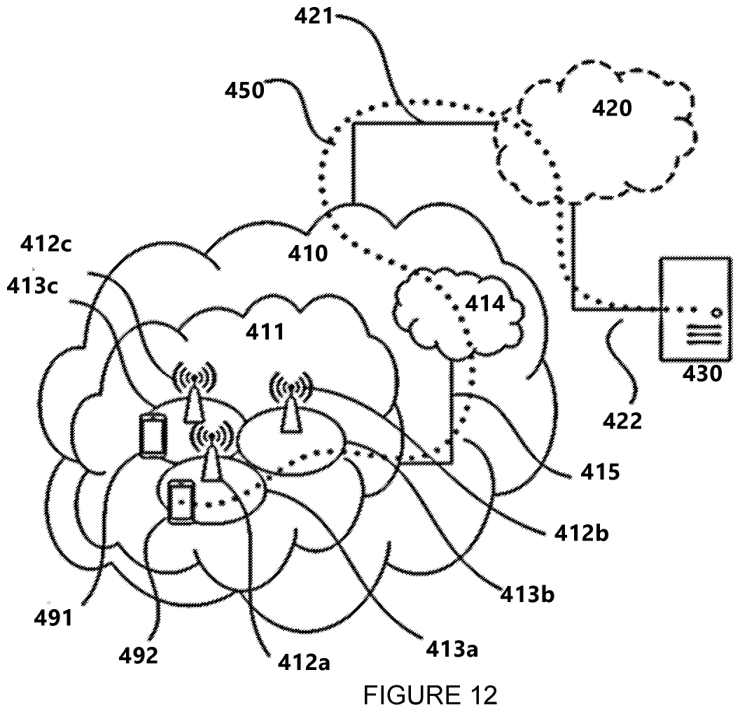

With reference to FIG. 12, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

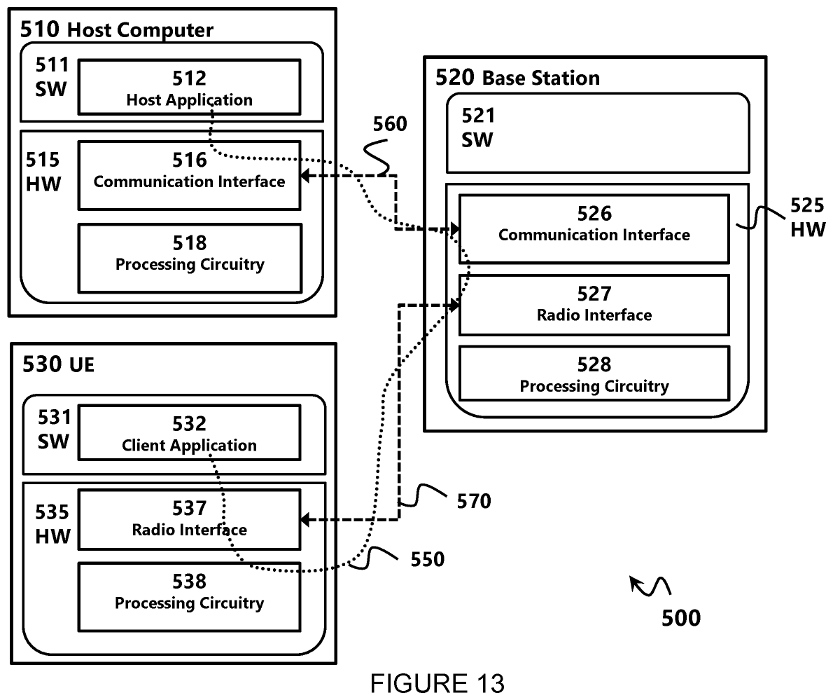

Example implementations, in accordance with an embodiment, of the UE, base station and host computer discussed in the preceding paragraphs will now be described with reference to FIG. 13. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve positioning accuracy (horizontal and vertical) with low latency and network efficiency (scalability, reference signal (RS) overhead, etc.).

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

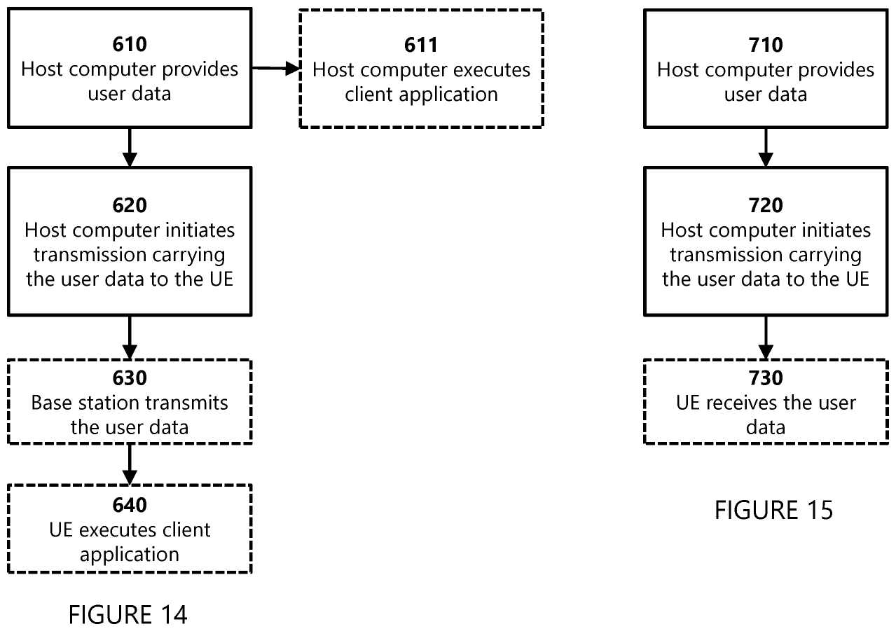

FIG. 14 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 14 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

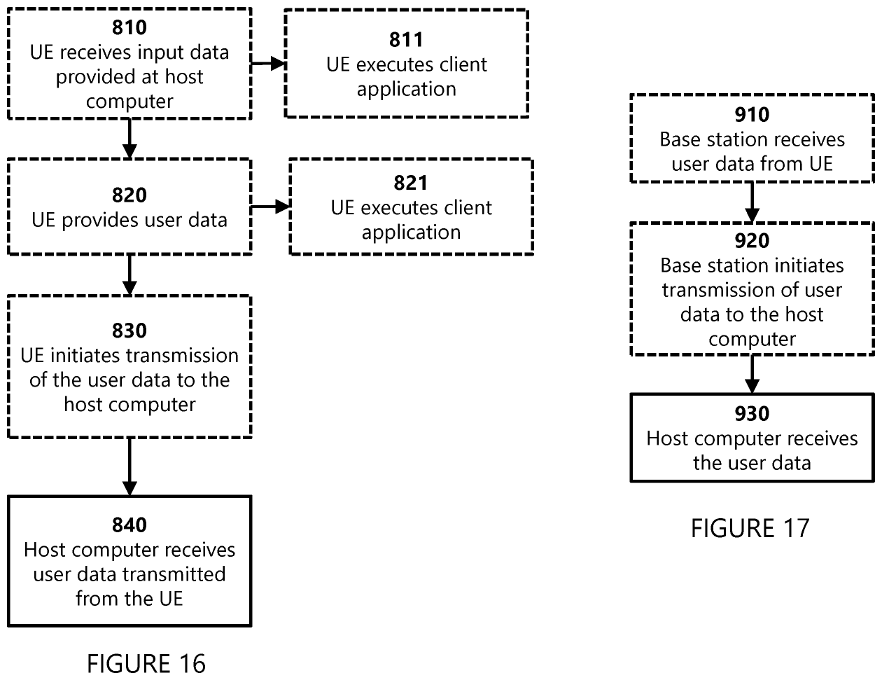

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

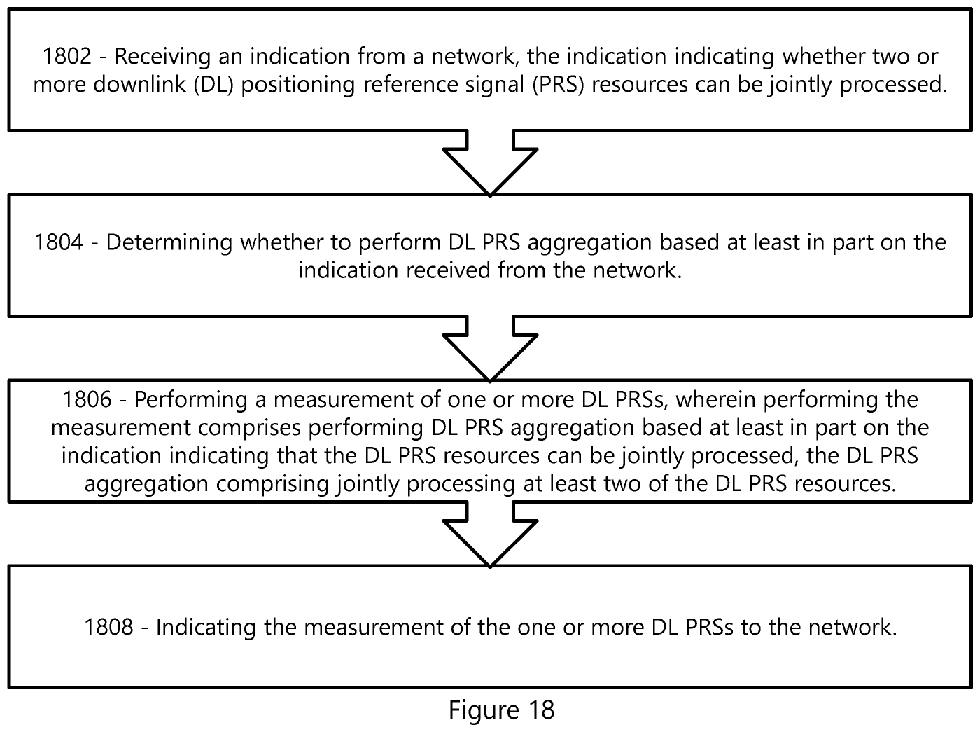

FIG. 18 depicts a method in accordance with particular embodiments. In certain embodiments, the method may be performed by a wireless device (such as wireless device 110, e.g., UE 200, discussed above). The method begins at step 1802 with receiving an indication from a network. The indication indicates whether two or more DL PRS resources can be jointly processed. The method proceeds to step 1804 with determining whether to perform DL PRS aggregation based at least in part on the indication received from the network. In some embodiments, the determining is further based on whether one or more conditions for performing DL PRS aggregation have been met (see e.g., the above description of “Embodiment 2: Conditions for coherently/jointly combining DL PRS resources.”). The method proceeds to step 1806 with performing a measurement of one or more DL PRSs. Performing the measurement comprises performing DL PRS aggregation based at least in part on the indication indicating that the DL PRS resources can be jointly processed. The DL PRS aggregation comprising jointly processing at least two of the DL PRS resources. The method proceeds to step 1808 with indicating the measurement of the one or more DL PRSs to the network.

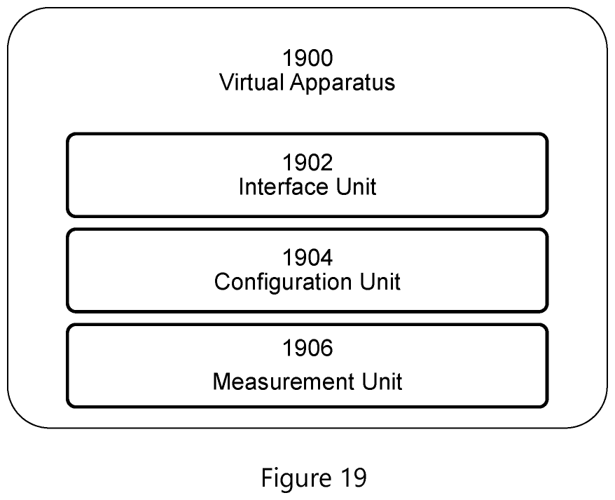

FIG. 19 illustrates a schematic block diagram of an apparatus 1900 in a wireless network (for example, the wireless network shown in FIG. 9). The apparatus may be implemented in a wireless device or network node (e.g., wireless device 110 or network node 160 shown in FIG. 9). Apparatus 1900 is operable to carry out the example method described with reference to FIG. 18 and possibly any other processes or methods disclosed herein. It is also to be understood that the method of FIG. 18 is not necessarily carried out solely by apparatus 1900. At least some operations of the method can be performed by one or more other entities.

Virtual Apparatus 1900 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause an interface unit 1902, a configuration unit 1904, a measurement unit 1906, and any other suitable units of apparatus 1900 to perform corresponding functions according one or more embodiments of the present disclosure.

As illustrated in FIG. 19, apparatus 1900 includes an interface unit 1902, a configuration unit 1904, and a measurement unit 1906. The interface unit 1902 is configured to communicate messages between the wireless device and the network node. The configuration unit 1904 is configured to determine a configuration to be used by the wireless device and apply the configuration to the wireless device. The measurement unit 1906 is configured to measure DL PRSs. As an example, in certain embodiments, interface unit 1902 receives a request for the wireless device to perform a DL PRS measurement. The request includes an indication that indicates whether two or more DL PRS resources can be jointly processed. The interface unit 1902 provides the indication to the configuration unit 1904. The configuration unit 1904 determines, based at least in part on the indication, whether to configure the measurement unit 1906 to jointly process two or more DL PRS resources and, if so, which DL PRS resources to jointly process. As an example, the indication may comprise a first index associated with a first DL PRS resource and a second index associated with a second DL PRS resource. The configuration unit 1904 may determine that the first DL PRS resource and the second DL PRS resource can be jointly processed based at least in part on the first index being the same as the second index. In some embodiments, the determination may be further based on whether one or more conditions for performing DL PRS aggregation have been met (see e.g., the above description of “Embodiment 2: Conditions for coherently/jointly combining DL PRS resources.”). Measurement unit 1906 performs the measurement based on the configuration. As an example, measurement unit jointly processes two or more DL PRS resources (if configured for such processing) or processes only one of the DL PRS resources (if not configured to jointly process two or more DL PRS resources, e.g., based on the indication from the network or because one or more conditions for coherently combining DL PRS resources have not been met). Measurement unit 1906 may provide the measurement to interface unit 1902, and interface unit 1902 may communicate the measurement to the network.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

### Embodiments

### Group A Embodiments

1. A method performed by a wireless device, the method comprising:
   receiving an indication from a network, the indication indicating whether two or more downlink (DL) positioning reference signal (PRS) resources can be jointly processed.
2. The method of embodiment 1, further comprising determining whether to perform DL PRS aggregation based at least in part on the indication received from the network.
3. The method of any of embodiments 1-2, further comprising performing a measurement of one or more DL PRSs.
4. The method of any of embodiments 1-3, wherein performing the measurement comprises performing DL PRS aggregation, the DL PRS aggregation performed based at least in part on the indication indicating that the DL PRS resources can be jointly processed.
5. The method of embodiment 4, wherein performing DL PRS aggregation comprises jointly processing at least two of the DL PRS resources.
6. The method of any of embodiments 4-5, wherein performing DL PRS aggregation is further based on determining that one or more conditions for jointly processing at least two of the DL PRS resources have been met.
7. The method of embodiment 6, wherein at least one of the conditions requires the two or more DL PRS resources being jointly processed to be transmitted from the same transmission and reception point (TRP).
8. The method of any of embodiments 6-7, wherein at least one of the conditions requires the two or more DL PRS resources being jointly processed to be received by the wireless device in the same slot.
9. The method of any of embodiments 6-8, wherein at least one of the conditions requires the two or more DL PRS resources being jointly processed to be received by the wireless device in the same symbol.
10. The method of any of embodiments 6-9, wherein at least one of the conditions requires the two or more DL PRS resources being jointly processed to be limited to a single repetition.
11. The method of any of embodiments 6-10, wherein at least one of the conditions requires the two or more DL PRS resources being jointly processed to be received by the wireless device with the same QCL information.
12. The method of any of embodiments 6-11, wherein at least one of the conditions requires the two or more DL PRS resources being jointly processed to belong to different frequency layers.
13. The method of any of embodiments 6-12, wherein at least one of the conditions requires the two or more DL PRS resources being jointly processed to use the same subcarrier spacing.
14. The method of any of embodiments 6-13, wherein performing the measurement comprises abstaining from performing DL PRS aggregation (e.g., processing only one of the DL PRS resources), the abstaining based on at least one of the one or more conditions not being met.
15. The method of embodiment 3, wherein performing the measurement comprises abstaining from performing DL PRS aggregation (e.g., processing only one of the DL PRS resources), the abstaining based on the indication indicating that the DL PRS resources cannot be jointly processed.
16. The method of any of embodiments 3-15, further comprising indicating the measurement of the one or more DL PRSs to the network.
17. The method of any of embodiments 1-16, wherein the indication whether the two or more DL PRS resources can be jointly processed is based on a phase difference between a first carrier associated with a first DL PRS resource and a second carrier associated with a second DL PRS resource.
18. The method of embodiment 17, wherein the indication indicates that the two or more DL PRS resources can be jointly processed when the phase difference indicates that the first carrier and the second carrier are sufficiently coherent (e.g., fully coherent).
19. The method of embodiment 17, wherein the indication indicates that the two or more DL PRS resources cannot be jointly processed when the phase difference indicates that the first carrier and the second carrier are not sufficiently coherent (e.g., completely incoherent).
20. The method of any of embodiments 18-19, wherein whether the first carrier and the second carrier are sufficiently coherent is based on whether a coherency value exceeds a threshold.
21. The method of any of embodiments 1-20, wherein the indication is received from a location node (e.g., location server, LMF).
22. The method of any of embodiments 1-21, wherein the indication is received via non-access stratum (NAS) signaling.
23. The method of any of embodiments 1-22, wherein the indication is received according to a positioning protocol (e.g., LPP, NRPPa) or OAM.
24. The method of any of embodiments 1-20, wherein the indication is received from a radio network node (e.g., base station, such as an eNB or gNB).
25. The method of any of embodiments 1-20 or 24, wherein the indication is received via radio resource control (RRC) signaling.
26. The method of any of embodiments 1-20 or 24, wherein the indication is received via downlink control information (DCI).
27. The method of any of embodiments 1-26, wherein the indication comprises a first index associated with a first DL PRS resource and a second index associated with a second DL PRS resource, and the indication indicates that the first DL PRS resource and the second DL PRS resource can be jointly processed when the first index is the same as the second index.
28. The method of any of embodiments 1-27, wherein the indication is received in a DL PRS resource configuration.
29. The method of any of embodiments 1-27, wherein the indication is received at a frequency layer level.
30. The method of any of embodiments 1-27, wherein the indication is configured at a DL PRS resource set level.
31. The method of any of embodiments 1-30, further comprising sending the network information indicating a maximum number of DL PRS resources that the wireless device can jointly process.
32. The method of any of the previous embodiments, further comprising:
   providing user data; and
   forwarding the user data to a host computer via the transmission to the base station.
Group B Embodiments
   33. A method performed by a network node, the method comprising:
sending an indication to a wireless device, the indication indicating whether two or more downlink (DL) positioning reference signal (PRS) resources can be jointly processed.
34. The method of embodiment 33, further comprising sending the wireless device information about one or more conditions that must be met in order to jointly process at least two of the DL PRS resources.
35 The method of embodiment 34, wherein the one or more conditions comprise at least one of the conditions of any of Group A embodiments 7-13.
36. The method of any of embodiments 33-35, further comprising receiving an indication of a measurement of one or more DL PRSs from the wireless device.
37. The method of embodiment 36, wherein the indication sent to the wireless device indicates that the two or more DL PRS resources can be jointly processed and the measurement is based on the wireless device jointly processing the two or more DL PRS resources.
38. The method of embodiment 36, wherein the indication sent to the wireless device indicates that the two or more DL PRS resources cannot be jointly processed and the measurement is based on the wireless device processing only one of the two or more DL PRS resources.
39. The method of any of embodiments 33-38, further comprising determining whether the two or more DL PRS resources can be jointly processed.
40. The method of embodiment 39, wherein determining whether the two or more DL PRS resources can be jointly processed is based on a phase difference between a first carrier associated with a first DL PRS resource and a second carrier associated with a second DL PRS resource.
41. The method of embodiment 40, wherein it is determined that the two or more DL PRS resources can be jointly processed when the phase difference indicates that the first carrier and the second carrier are sufficiently coherent (e.g., fully coherent).
42. The method of embodiment 40, wherein it is determined that the two or more DL PRS resources cannot be jointly processed when the phase difference indicates that the first carrier and the second carrier are not sufficiently coherent (e.g., completely incoherent).
43. The method of any of embodiments 41-42, wherein whether the first carrier and the second carrier are sufficiently coherent is based on whether a coherency value exceeds a threshold.
44. The method of any of embodiments 33-43, wherein the network node comprises a location node (e.g., location server, LMF).
45. The method of any of embodiments 33-44, wherein the indication is sent via non-access stratum (NAS) signaling.
46. The method of any of embodiments 33-45, wherein the indication is sent according to a positioning protocol (e.g., LPP, NRPPa) or OAM.
47. The method of any of embodiments 33-43, wherein the network node comprises a radio network node (e.g., base station, such as an eNB or gNB).
48. The method of any of embodiments 33-43 or 47, wherein the indication is sent via radio resource control (RRC) signaling.
49. The method of any of embodiments 33-43 or 37, wherein the indication is sent via downlink control information (DCI).
50. The method of any of embodiments 33-49, wherein the indication comprises a first index associated with a first DL PRS resource and a second index associated with a second DL PRS resource, and the indication indicates that the first DL PRS resource and the second DL PRS resource can be jointly processed when the first index is the same as the second index.
51. The method of any of embodiments 33-50, wherein the indication is sent in a DL PRS resource configuration.
52. The method of any of embodiments 33-50, wherein the indication is sent at a frequency layer level.
53. The method of any of embodiments 33-50, wherein the indication is configured at a DL PRS resource set level.
54. The method of any of embodiments 33-53, wherein a number of DL PRS resources that the indication indicates can be jointly processed is less than a maximum number of DL PRS resources that the wireless device can jointly process.
55. The method of embodiment 54, further comprising receiving the maximum number of DL resources that the wireless device can jointly process from the wireless device.
56. The method of embodiment 54, wherein the maximum number of DL resources that the wireless device can jointly process is defined in a standard.
57. A method performed by a radio network node (e.g., NG-RAN node, base station, eNB, gNB, SgNB, NgNB), the method comprising:
   sending an indication to a location node (e.g., location server, LMF), the indication indicating whether two or more downlink (DL) positioning reference signal (PRS) resources can be jointly processed.
58. The method of embodiment 57, wherein the indication is sent in response to a receiving a request from the location node to provide information on transmission reception points (TRPs) hosted by the radio network node.
59. The method of embodiment 57 or 58, further comprising determining whether the two or more DL PRS resources can be jointly processed. (See e.g., embodiments 40-43).
60. A method performed by a location node (e.g., location server, LMF), the method comprising:
   receiving an indication from a radio network node, the indication indicating whether two or more downlink (DL) positioning reference signal (PRS) resources can be jointly processed; and
   sending a wireless device a request to provide a DL PRS measurement, the request indicating whether the two or more DL PRS resources can be jointly processed.
61. The method of embodiment 60, wherein the request is sent via NAS signaling.
62. The method of embodiment 60 or 61, wherein the request is sent according to a positioning protocol (e.g., LPP or NRPPa) or OAM.
63. The method of any of embodiments 60-62, further comprising receiving the DL PRS measurement from the wireless device and determining a position of the wireless device based at least in part on the DL PRS measurement.
64. The method of any of the previous embodiments, further comprising:
   obtaining user data; and
   forwarding the user data to a host computer or a wireless device.

### Group C Embodiments

65. A wireless device, the wireless device comprising:
   processing circuitry configured to perform any of the steps of any of the Group A embodiments; and
   power supply circuitry configured to supply power to the wireless device.
66. A base station, the base station comprising:
   processing circuitry configured to perform any of the steps of any of the Group B embodiments;
   power supply circuitry configured to supply power to the base station.
67. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
68. A computer program, the computer program comprising instructions which when executed on a computer perform any of the steps of any of the Group A embodiments.
69. A computer program product comprising a computer program, the computer program comprising instructions which when executed on a computer perform any of the steps of any of the Group A embodiments.
70. A non-transitory computer-readable storage medium or carrier comprising a computer program, the computer program comprising instructions which when executed on a computer perform any of the steps of any of the Group A embodiments.
71. A computer program, the computer program comprising instructions which when executed on a computer perform any of the steps of any of the Group B embodiments.
72. A computer program product comprising a computer program, the computer program comprising instructions which when executed on a computer perform any of the steps of any of the Group B embodiments.
73. A non-transitory computer-readable storage medium or carrier comprising a computer program, the computer program comprising instructions which when executed on a computer perform any of the steps of any of the Group B embodiments.
74. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
75. The communication system of the pervious embodiment further including the base station.
76. The communication system of the previous 2 embodiments, further including the UE, wherein the UE is configured to communicate with the base station.
77. The communication system of the previous 3 embodiments, wherein:
   the processing circuitry of the host computer is configured to execute a host application, thereby providing the user data; and
   the UE comprises processing circuitry configured to execute a client application associated with the host application.
78. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
79. The method of the previous embodiment, further comprising, at the base station, transmitting the user data.
80. The method of the previous 2 embodiments, wherein the user data is provided at the host computer by executing a host application, the method further comprising, at the UE, executing a client application associated with the host application.
81. A user equipment (UE) configured to communicate with a base station, the UE comprising a radio interface and processing circuitry configured to performs the of the previous 3 embodiments.
82. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
83. The communication system of the previous embodiment, wherein the cellular network further includes a base station configured to communicate with the UE.
84. The communication system of the previous 2 embodiments, wherein:
   the processing circuitry of the host computer is configured to execute a host application, thereby providing the user data; and
   the UE's processing circuitry is configured to execute a client application associated with the host application.
85. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
86. The method of the previous embodiment, further comprising at the UE, receiving the user data from the base station.
87. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
88. The communication system of the previous embodiment, further including the UE.
89. The communication system of the previous 2 embodiments, further including the base station, wherein the base station comprises a radio interface configured to communicate with the UE and a communication interface configured to forward to the host computer the user data carried by a transmission from the UE to the base station.
90. The communication system of the previous 3 embodiments, wherein:
   the processing circuitry of the host computer is configured to execute a host application; and
   the UE's processing circuitry is configured to execute a client application associated with the host application, thereby providing the user data.
91. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
92. A method implemented in a communication system including a host computer, a base station and a user equipment (UE), the method comprising:
   at the host computer, receiving user data transmitted to the base station from the UE, wherein the UE performs any of the steps of any of the Group A embodiments.
93. The method of the previous embodiment, further comprising, at the UE, providing the user data to the base station.
94. The method of the previous 2 embodiments, further comprising:
   at the UE, executing a client application, thereby providing the user data to be transmitted; and
   at the host computer, executing a host application associated with the client application.
95. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
96. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
97. The communication system of the previous embodiment further including the base station.
98. The communication system of the previous 2 embodiments, further including the UE, wherein the UE is configured to communicate with the base station.
99. The communication system of the previous 3 embodiments, wherein:
   the processing circuitry of the host computer is configured to execute a host application;
   the UE is configured to execute a client application associated with the host application, thereby providing the user data to be received by the host computer.
100. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
101. The method of the previous embodiment, further comprising at the base station, receiving the user data from the UE.
102. The method of the previous 2 embodiments, further comprising at the base station, initiating a transmission of the received user data to the host computer.

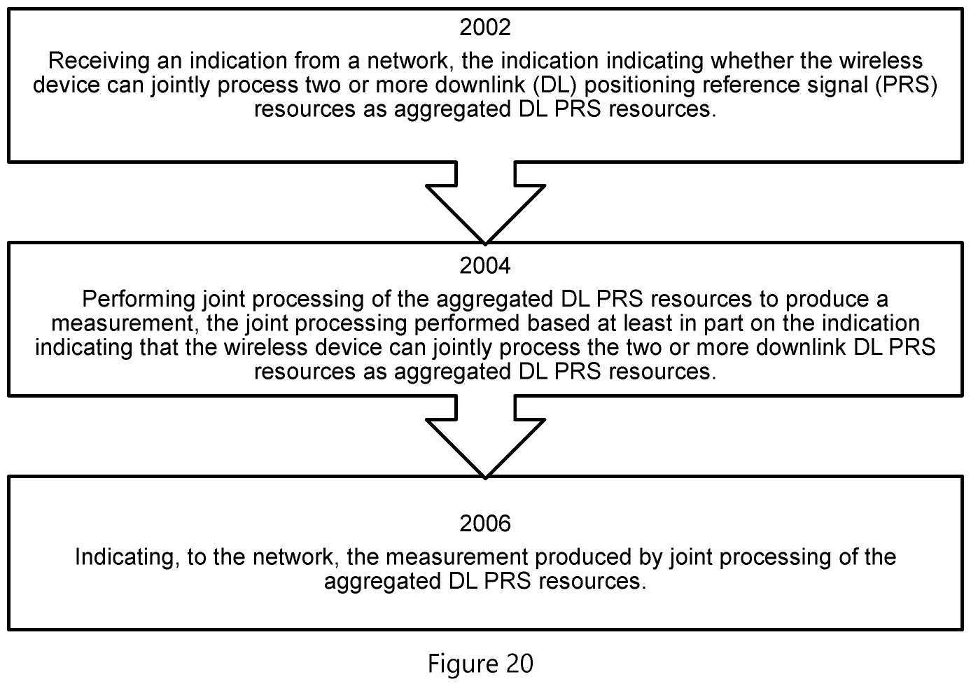

FIG. 20 illustrates an example of a method performed by a wireless device, such as wireless device 110 or UE 200. In certain embodiments, the wireless device comprises processing circuitry (such as processing circuitry 120 or processor 201) configured to perform the method. For example, the processing circuitry may be configured to execute a computer program comprising instructions to perform any of the steps of the method.

In certain embodiments, the method begins at step 2002 with receiving an indication from a network. The indication indicates whether the wireless device can jointly process two or more DL PRS resources as aggregated DL PRS resources. The wireless device may receive the indication from any suitable node in the network, such as a location node (e.g., a location server or LMF) or a radio network node (e.g., a base station, such as a gNB or eNB). The indication may be received via NAS signaling, according to a positioning protocol, via an OAM message, via RRC signaling, via DCI, or other suitable type of signaling. As an example, a location node may communicate the indication according to a positioning protocol via NAS signaling. As another example, a radio network node may communicate the indication via RRC signaling or DCI.

Examples of indications that may be received from the network in step 2002 are described above with respect to “Embodiment 1: Signaling aggregated downlink PRS to the UE” (e.g., describing embodiments where a location node sends an indication to the wireless device), “Embodiment 3: Extensions to RRC configured DL PRS and other reference signals” (e.g., describing embodiments where a radio network node sends an indication to the wireless device), “Embodiment 4: Indicating DL PRS aggregation from NG-RAN Node to the LMF” (e.g., describing embodiments of a location node that receives information from an NG-RAN node and sends an indication to the wireless device based on the information received from the NG-RAN node), and “Embodiment 5: Indicating Cell based DL PRS aggregation” (e.g., describing embodiments of a location node that receives information from a gNB and sends an indication to the wireless device based on the information received from the gNB).

In certain embodiments, the indication indicating whether the wireless device can jointly process the two or more DL PRS resources comprises a first index associated with a first DL PRS resource and a second index associated with a second DL PRS resource. The indication indicates that the first DL PRS resource and the second DL PRS resource can be jointly processed when the first index is the same as the second index. The indication indicates that the first DL PRS resource and the second DL PRS resource cannot be jointly processed when the first index is different than the second index

The indication indicating whether the wireless device can jointly process the two or more DL PRS resources can be configured at any suitable level, such as at a DL PRS resource configuration, at a frequency layer level, or at a DL PRS resource set level.

In certain embodiments, the indication indicating whether the wireless device can jointly process the two or more DL PRS resources is based on a phase difference between a first carrier associated with a first DL PRS resource and a second carrier associated with a second DL PRS resource. For example, the indication indicates that the two or more DL PRS resources can be jointly processed when the phase difference indicates that the first carrier and the second carrier are sufficiently coherent. In certain embodiments, whether the first carrier and the second carrier are sufficiently coherent is based on whether a coherency value exceeds a threshold.

Certain embodiments send the network (e.g., location node or radio network node) information indicating a maximum number of DL PRS resources that the wireless device is capable of jointly processing. The information may be sent prior to step 2002. The network can use the information to determine a number of DL PRS resources to indicate that the wireless device can jointly process as aggregated DL PRS resources. Thus, the indication received in step 2002 may indicate that the wireless device can jointly process the maximum number of DL PRS resources or a number less than the maximum number of DL PRS resources.

Continuing with the description of FIG. 20, the method proceeds to step 2004 with performing joint processing of the aggregated DL PRS resources to produce a measurement. Aggregation of DL PRS resources can be distinguished from merely averaging multiple measurements from different DL PRS resources because aggregation of DL PRS resources involves joint processing of the DL PRS resources to produce a measurement. The joint processing in step 2004 is performed based at least in part on the indication in step 2002 indicating that the wireless device can jointly process the two or more downlink DL PRS resources as aggregated DL PRS resources. The method proceeds to step 2006 with indicating, to the network, the measurement produced by joint processing of the aggregated DL PRS resources in step 2004. In certain embodiments, the wireless device indicates the measurement to a location node (e.g., location server or LMF) in the network, for example, via non-access stratum signaling. Other embodiments indicate the measurement to a radio network node in the network (e.g., the radio network node can send the measurement to the location node).

In certain embodiments, performing the joint processing is further based on determining that one or more conditions for jointly processing the two or more DL PRS resources have been met. Examples of conditions are described above with respect to “Embodiment 2: Conditions for coherently/jointly combining DL PRS resources.” For example, performing the joint processing may be further based on determining that one or more of the following conditions have been met:
A condition that requires two or more DL PRS resources being jointly processed to be transmitted from the same TRP.
A condition that requires the two or more DL PRS resources being jointly processed to be received by the wireless device in the same slot.
A condition that requires the two or more DL PRS resources being jointly processed to be received by the wireless device in the same symbol.
A condition that requires the two or more DL PRS resources being jointly processed to be limited to a single repetition.
A condition that requires the two or more DL PRS resources being jointly processed to be received by the wireless device with the same QCL information.
A condition that requires the two or more DL PRS resources being jointly processed to belong to different frequency layers.
A condition that requires the two or more DL PRS resources being jointly processed to use the same subcarrier spacing.

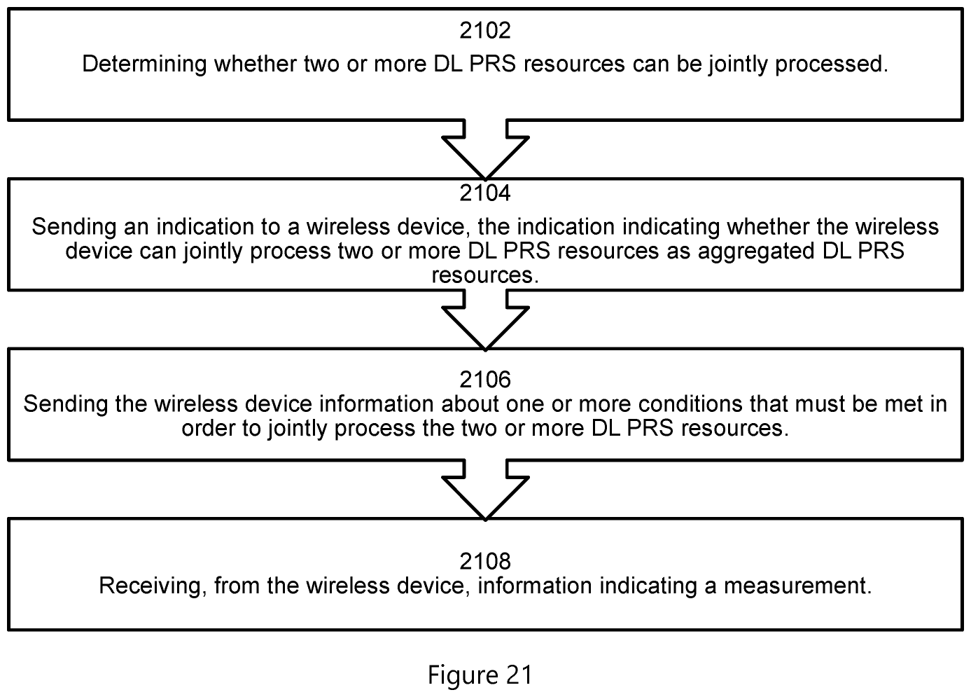

FIG. 21 illustrates an example of a method performed by a network node, such as network node 160. Examples of the network node include a radio network node (e.g., base station, eNB, gNB, etc.) or a location node (e.g., location server, LMF, etc.). In certain embodiments, the network node comprises processing circuitry (such as processing circuitry 170) configured to perform the method. For example, the processing circuitry may be configured to execute a computer program comprising instructions to perform any of the steps of the method.

In certain embodiments, the method begins at step 2102 with determining whether two or more DL PRS resources can be jointly processed. As an example, determining whether the two or more DL PRS resources can be jointly processed may be based on a phase difference between a first carrier associated with a first DL PRS resource and a second carrier associated with a second DL PRS resource. Certain embodiments determine that the two or more DL PRS resources can be jointly processed when the phase difference indicates that the first carrier and the second carrier are sufficiently coherent. Certain embodiments determine that the two or more DL PRS resources cannot be jointly processed when the phase difference indicates that the first carrier and the second carrier are not sufficiently coherent. For example, whether the first carrier and the second carrier are sufficiently coherent is based on whether a coherency value exceeds a threshold.

Certain embodiments determine whether two or more DL PRS resources can be jointly processed based on information received from another network node. For example, a location node may determine whether two or more DL PRS resources can be jointly processed based on information received from an NG-RAN (see e.g., “Embodiment 4: Indicating DL PRS aggregation from NG-RAN Node to the LMF” above) or a gNB (see e.g., “Embodiment 5: Indicating Cell based DL PRS aggregation” above).

Certain embodiments determine whether two or more DL PRS resources can be jointly processed based at least in part on a maximum number of DL PRS resources that the wireless device is capable of jointly processing. Certain embodiments receive the maximum number of DL resources that the wireless device is capable of jointly processing from the wireless device. Certain embodiments determine the maximum number of DL resources that the wireless device is capable of jointly processing based on a standard.

The method proceeds to step 2104 with sending an indication to a wireless device. The indication indicates whether the wireless device can jointly process two or more DL PRS resources as aggregated DL PRS resources. The indication may be sent via NAS signaling, according to a positioning protocol, via an OAM message, via RRC signaling, via DCI, or other suitable type of signaling. As an example, a location node may communicate the indication according to a positioning protocol via NAS signaling. As another example, a radio network node may communicate the indication via RRC signaling or DCI. As another example, a radio network node may communicate the indication to the wireless device via the location node (the radio network node communicates an indication to the location node, and the location node communicates the indication to the wireless device). The indication indicating whether the wireless device can jointly process the two or more DL PRS resources can be configured at any suitable level, such as at a DL PRS resource configuration, at a frequency layer level, or at a DL PRS resource set level. In certain embodiments, a number of DL PRS resources that the indication indicates can be jointly processed is less than a maximum number of DL PRS resources that the wireless device is capable of jointly processing. In certain embodiments, the indication sent in step 2104 comprises a first index associated with a first DL PRS resource and a second index associated with a second DL PRS resource. The indication indicates that the first DL PRS resource and the second DL PRS resource can be jointly processed when the first index is the same as the second index (or, the indication indicates that the first DL PRS resource and the second DL PRS resource cannot be jointly processed when the first index is different than the second index). Further examples of an indication sent from a network node to a wireless device are described above, for example, with respect to step 2002 of FIG. 20 (e.g., the network node provides the reciprocal side of the signal flow between the wireless device and the network node).

At step 2106, the method sends the wireless device information about one or more conditions that must be met in order to jointly process the two or more DL PRS resources. Examples of such conditions are described above, for example, with respect to “Embodiment 2: Conditions for coherently/jointly combining DL PRS resources” and with respect to FIG. 20.

At step 2108, the method receives information from the wireless device. The information indicates a measurement. For example, if the indication sent to the wireless device in step 2104 indicates that the two or more DL PRS resources can be jointly processed, the information received in step 2108 may indicate a measurement based on the wireless device jointly processing the two or more DL PRS resources as aggregated DL PRS resources. If the indication sent to the wireless device in step 2104 indicates that the two or more DL PRS resources cannot be jointly processed, the information received in step 2108 may indicate a measurement based on the wireless device processing only one of the two or more DL PRS resources at a time (as opposed to joint processing). The measurement indicated in step 2108 may be used in determining a location or position of the wireless device.

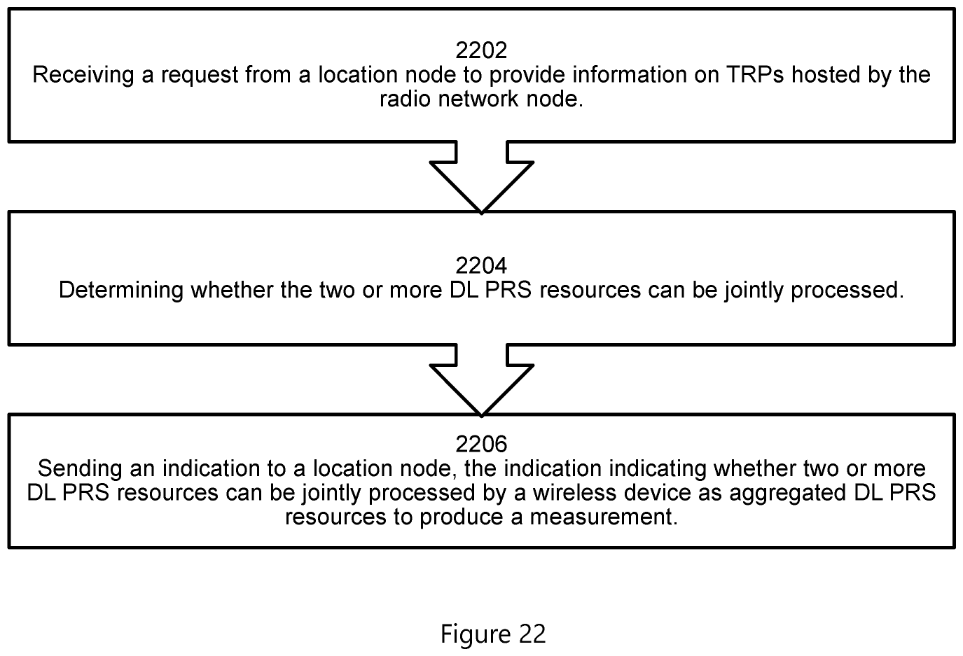

FIG. 22 illustrates an example of a method performed by a radio network node, such as network node 160 that implements a base station (e.g., an eNB or gNB). In certain embodiments, the radio network node comprises processing circuitry (such as processing circuitry 170) configured to perform the method. For example, the processing circuitry may be configured to execute a computer program comprising instructions to perform any of the steps of the method.

In certain embodiments, the method begins at step 2202 with receiving a request from a location node to provide information on TRPs hosted by the radio network node. The method proceeds to step 2204 with determining whether the two or more DL PRS resources can be jointly processed. This step may be analogous to step 2102 of FIG. 21. The method proceeds to step 2206 with sending an indication to a location node, the indication indicating whether two or more DL PRS resources can be jointly processed by a wireless device as aggregated DL PRS resources to produce a measurement. For example, see “Embodiment 4: Indicating DL PRS aggregation from NG-RAN Node to the LMF” or “Embodiment 5: Indicating Cell based DL PRS aggregation” above. The location node may use the indication received from the radio network node to indicate the to the wireless device whether two or more DL PRS resources can be jointly processed by the wireless device.

Optionally, the method of FIG. 22 may include additional steps described herein as being performed by a radio network node, such as communicating, to the location node or the wireless device, one or more conditions for jointly processing the two or more DL PRS. Examples of conditions are described above, for example, with respect to FIG. 20.

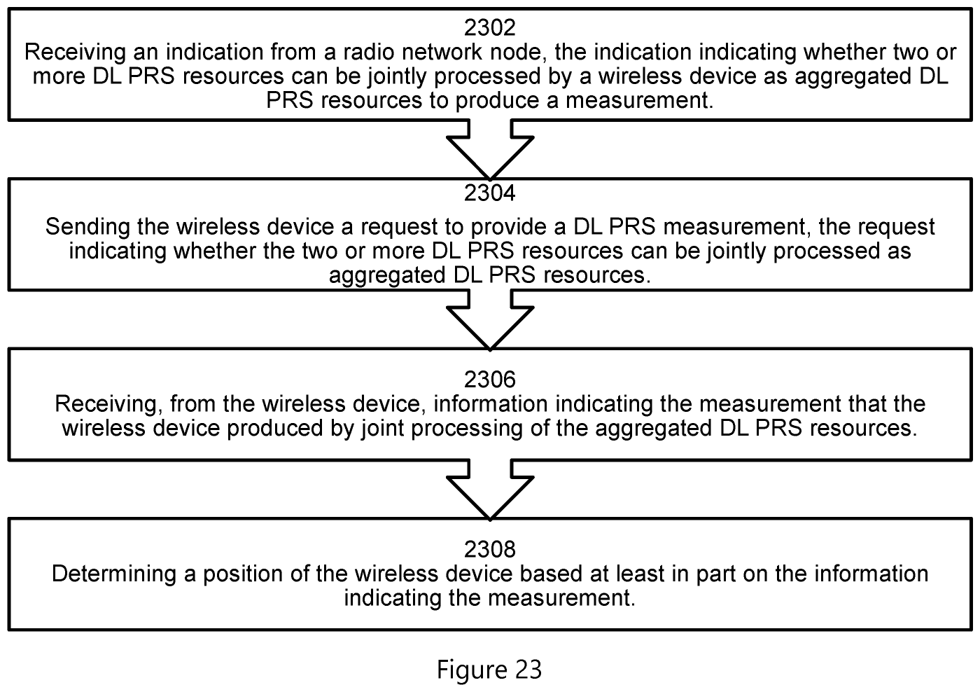

FIG. 23 illustrates an example of a method performed by a location node, such as a network node 160c that implements a location server or LMF. In certain embodiments, the location node comprises processing circuitry configured to perform the method. For example, the processing circuitry may be configured to execute a computer program comprising instructions to perform any of the steps of the method.

In certain embodiments, the method begins at step 2302 with receiving an indication from a radio network node, the indication indicating whether two or more DL PRS resources can be jointly processed by a wireless device as aggregated DL PRS resources to produce a measurement. In certain embodiments, the method may prompt the radio network node to send the indication, for example, by sending the radio network node a request to provide information on TRPs hosted by the radio network node. Examples of indications that may be received by the location node include “Embodiment 4: Indicating DL PRS aggregation from NG-RAN Node to the LMF” or “Embodiment 5: Indicating Cell based DL PRS aggregation” above. In certain embodiments, the information indicates that the DL PRS resources can be jointly processed when the DL PRS resources are sufficiently coherent.

The method proceeds to step 2304 with sending the wireless device a request to provide a DL PRS measurement. The request indicates whether the two or more DL PRS resources can be jointly processed as aggregated DL PRS resources (e.g., based on the information that the location node received from the radio network node in step 2302). Examples of an indication that may be sent to the wireless device are described above, for example, with respect to step 2002 of FIG. 20 (e.g., the location node provides the reciprocal side of the signal flow between the wireless device and the network node/location node).

The method proceeds to step 2306 with receiving, from the wireless device, information indicating the measurement that the wireless device produced by joint processing of the aggregated DL PRS resources, and then to step 2308 with determining a position of the wireless device based at least in part on the information indicating the measurement received in step 2306.

Optionally, the method of FIG. 23 may include additional steps described herein as being performed by a location node, such as communicating, to the wireless device, one or more conditions for jointly processing the two or more DL PRS. Examples of conditions are described above, for example, with respect to FIG. 20.

Certain embodiments of the present disclosure address the issue of signaling to a wireless device multiple DL PRS resources that can be jointly processed (coherently) by the wireless device for positioning purpose. The signaling to the wireless device can be from a radio network node (such as a serving gNB or eNB) or from a location node (such as a location server or LMF). In certain embodiments, the multiple DL PRS could be from a same transmission point but different frequency layers or different component carriers (e.g., in case of carrier aggregation). The disclosure proposes several embodiments. As an example, certain embodiments configured, by a radio network node to a wireless device, an index in each DL PRS resource. DL PRS resources having the same index value can be jointly (coherently) processed by the wireless device. Various options exist for configuring the index. For example, the index can be configured in frequency layers, component carriers, or DL PRS resource sets. DL PRS resources associated with frequency layers, component carriers, or PRS resource sets having the same index value can be jointly (coherently) processed by the wireless device. As another example, certain embodiments use other RS for the purpose, such as SSB/CSI-RS (instead of DL PRS). As another example, in certain embodiments, instead of signaling from the radio network node to the wireless device, the information may be provided by the radio network node to the location node, and the location node takes into account the information when configuring the DL PRS to the wireless device.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set. As used in this document, “based on” means “based at least in part on” unless a different meaning is clearly given and/or is implied from the context in which it is used.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the following claims.

1. A method performed by a wireless device, the method comprising:
receiving an indication from a network, the indication indicating whether the wireless device can jointly process two or more downlink (DL) positioning reference signal (PRS) resources as aggregated DL PRS resources; and
performing joint processing of the aggregated DL PRS resources to produce a measurement, the joint processing performed based at least in part on the indication indicating that the wireless device can jointly process the two or more downlink DL PRS resources as aggregated DL PRS resources.

2. The method of claim 1, wherein performing the joint processing is further based on determining that one or more conditions for jointly processing the two or more DL PRS resources have been met.

3. The method of claim 1, wherein performing the joint processing is further based on determining that a condition has been met that requires the two or more DL PRS resources being jointly processed to be transmitted from the same transmission and reception point (TRP).

4. The method of claim 1, wherein performing the joint processing is further based on determining that a condition has been met that requires the two or more DL PRS resources being jointly processed to be received by the wireless device in a same time or frequency slot.

5. The method of claim 4, wherein performing the joint processing is further based on determining that a condition has been met that requires the two or more DL PRS resources being jointly processed to be received by the wireless device in a same symbol within the same time or frequency slot.

6. The method of claim 1, wherein performing the joint processing is further based on determining that a condition has been met that requires the two or more DL PRS resources being jointly processed to be limited to a single repetition.

7. The method of claim 1, wherein performing the joint processing is further based on determining that a condition has been met that requires the two or more DL PRS resources being jointly processed to be received by the wireless device with the same quasi co-location (QCL) information.

8. The method of claim 1, wherein performing the joint processing is further based on determining that a condition has been met that requires the two or more DL PRS resources being jointly processed to belong to different frequency layers.

9. The method of claim 1, wherein performing the joint processing is further based on determining that a condition has been met that requires the two or more DL PRS resources being jointly processed to use the same subcarrier spacing.

10. The method of claim 1, further comprising indicating, to the network, the measurement produced by joint processing of the aggregated DL PRS resources.

11. The method of claim 10, wherein the measurement is indicated to a location node.

12. The method of claim 10, wherein the measurement is indicated to a radio network node.

13. The method of claim 1, wherein the indication indicating whether the wireless device can jointly process the two or more DL PRS resources is based on a phase difference between a first carrier associated with a first DL PRS resource and a second carrier associated with a second DL PRS resource.

14. The method of claim 13, wherein the indication indicates that the two or more DL PRS resources can be jointly processed when the phase difference indicates that the first carrier and the second carrier are sufficiently coherent.

15. The method of claim 14, wherein whether the first carrier and the second carrier are sufficiently coherent is based on whether a coherency value exceeds a threshold.

16. The method of claim 1, wherein the indication indicating whether the wireless device can jointly process the two or more DL PRS resources is received from a location node.

17. The method of claim 1, wherein the indication indicating whether the wireless device can jointly process the two or more DL PRS resources is received via non-access stratum (NAS) signaling.

18. The method of claim 1, wherein the indication indicating whether the wireless device can jointly process the two or more DL PRS resources is received according to a positioning protocol or an Operations, Administration and Maintenance (OAM) message.

19. The method of claim 1, wherein the indication indicating whether the wireless device can jointly process the two or more DL PRS resources is received from a radio network node.

20. The method of claim 1, wherein the indication indicating whether the wireless device can jointly process the two or more DL PRS resources is received via radio resource control (RRC) signaling.

21. The method of claim 1, wherein the indication indicating whether the wireless device can jointly process the two or more DL PRS resources is received via downlink control information (DCI).

22. The method of claim 1, wherein the indication indicating whether the wireless device can jointly process the two or more DL PRS resources comprises a first index associated with a first DL PRS resource and a second index associated with a second DL PRS resource, and the indication indicates that the first DL PRS resource and the second DL PRS resource can be jointly processed when the first index is the same as the second index.

23.-26. (canceled)

27. A method performed by a network node, the method comprising:
sending an indication to a wireless device, the indication indicating whether the wireless device can jointly process two or more downlink (DL) positioning reference signal (PRS) resources as aggregated DL PRS resources.

28.-55. (canceled)

56. A method performed by a radio network node, the method comprising:
sending an indication to a location node, the indication indicating whether two or more downlink (DL) positioning reference signal (PRS) resources can be jointly processed by a wireless device as aggregated DL PRS resources to produce a measurement.

57.-62. (canceled)

63. A wireless device, the wireless device comprising:
power supply circuitry configured to supply power to the wireless device; and
processing circuitry, the processing circuitry configured to:
receive an indication from a network, the indication indicating whether the wireless device can jointly process two or more downlink (DL) positioning reference signal (PRS) resources as aggregated DL PRS resources; and
perform joint processing of the aggregated DL PRS resources to produce a measurement, the joint processing performed based at least in part on the indication indicating that the wireless device can jointly process the two or more downlink DL PRS resources as aggregated DL PRS resources.

64.-66. (canceled)

67. A radio network node, the radio network node comprising:
power supply circuitry configured to supply power to the radio network node; and
processing circuitry, the processing circuitry configured to:
send an indication to a location node, the indication indicating whether two or more downlink (DL) positioning reference signal (PRS) resources can be jointly processed by a wireless device as aggregated DL PRS resources to produce a measurement.

68.-70. (canceled)
